(19) United States
(12) Patent Application Publication
(10) Pub. No.: US 2024/0406236 A1
(43) Pub. Date: Dec. 5, 2024

(54) TECHNIQUES FOR MANAGING PLAYBACK OF MEDIA

(71) Applicant: Apple Inc., Cupertino, CA (US)

(72) Inventor: Taylor G. CARRIGAN, San Francisco, CA (US)

(21) Appl. No.: 18/668,451

(22) Filed: May 20, 2024

Related U.S. Application Data
(60) Provisional application No. 63/470,982, filed on Jun. 5, 2023.

(51) Int. Cl. H04L 65/4038; H04L 12/18; H04L 65/613

(52) U.S. Cl. CPC H04L 65/4038; H04L 12/1831; H04L 65/613

(57) ABSTRACT

The present disclosure generally relates to managing the playback of media and managing the playback of recently played media.

### CROSS-REFERENCE TO RELATED APPLICATIONS

The present application claims priority to U.S. Provisional Patent Application Ser. No. 63/470,982 entitled “TECHNIQUES FOR MANAGING PLAYBACK OF MEDIA” filed Jun. 5, 2023, which is hereby incorporated by reference in its entirety for all purposes.

### FIELD

The present disclosure relates generally to computer user interfaces, and more specifically to techniques for managing physical storage devices.

### BACKGROUND

Electronic devices often control the playback of media. Electronic devices can control their own playback operations and/or control the playback operations of external electronic devices.

### SUMMARY

Some techniques for managing the playback of media using electronic devices, however, are generally cumbersome and inefficient. For example, some existing techniques use a complex and time-consuming user interface, which may include multiple key presses or keystrokes. Existing techniques require more time than necessary, wasting user time and device energy. This latter consideration is particularly important in battery-operated devices.

Accordingly, the present technique provides electronic devices with faster, more efficient methods and interfaces for managing the playback of media. Such methods and interfaces optionally complement or replace other methods for managing the playback of media. Such methods and interfaces reduce the cognitive burden on a user and produce a more efficient human-machine interface. For battery-operated computing devices, such methods and interfaces conserve power and increase the time between battery charges.

In some examples, a method that is performed at a first computer system that is in communication with a display generation component is described. In some examples, the method comprises: in accordance with a determination that a first set of one or more criteria is satisfied while a second computer system is outputting media, wherein the first set of one or more criteria includes a criterion that is satisfied when the first computer system is determined to be within a predefined distance from a third computer system while the second computer system is outputting media: causing, the third computer system, to output the media; and changing, via the display generation component, a display location of a first representation of the media from a first location to a second location, wherein the second location corresponds to a display location of a representation of the third computer system and the first location does not correspond to a location of the display location of the first representation of the third computer system; and in accordance with a determination that a second set of one or more criteria is satisfied, wherein the second set of one or more criteria includes a criterion that is satisfied when the first computer system is determined to be within the predefined distance from the third computer system while the second computer system is outputting media: forgoing causing the third computer system to output respective media; and forgoing changing the display location of the first representation of the media from the first location to the second location.

In some examples, a non-transitory computer-readable storage medium storing one or more programs configured to be executed by one or more processors of a first computer system that is in communication with a display generation component is described. In some examples, the one or more programs includes instructions for: in accordance with a determination that a first set of one or more criteria is satisfied while a second computer system is outputting media, wherein the first set of one or more criteria includes a criterion that is satisfied when the first computer system is determined to be within a predefined distance from a third computer system while the second computer system is outputting media: causing, the third computer system, to output the media; and changing, via the display generation component, a display location of a first representation of the media from a first location to a second location, wherein the second location corresponds to a display location of a representation of the third computer system and the first location does not correspond to a location of the display location of the first representation of the third computer system; and in accordance with a determination that a second set of one or more criteria is satisfied, wherein the second set of one or more criteria includes a criterion that is satisfied when the first computer system is determined to be within the predefined distance from the third computer system while the second computer system is outputting media: forgoing causing the third computer system to output respective media; and forgoing changing the display location of the first representation of the media from the first location to the second location.

In some examples, a transitory computer-readable storage medium storing one or more programs configured to be executed by one or more processors of a first computer system that is in communication with a display generation component is described. In some examples, the one or more programs includes instructions for: in accordance with a determination that a first set of one or more criteria is satisfied while a second computer system is outputting media, wherein the first set of one or more criteria includes a criterion that is satisfied when the first computer system is determined to be within a predefined distance from a third computer system while the second computer system is outputting media: causing, the third computer system, to output the media; and changing, via the display generation component, a display location of a first representation of the media from a first location to a second location, wherein the second location corresponds to a display location of a representation of the third computer system and the first location does not correspond to a location of the display location of the first representation of the third computer system; and in accordance with a determination that a second set of one or more criteria is satisfied, wherein the second set of one or more criteria includes a criterion that is satisfied when the first computer system is determined to be within the predefined distance from the third computer system while the second computer system is outputting media: forgoing causing the third computer system to output respective media; and forgoing changing the display location of the first representation of the media from the first location to the second location.

In some examples, a first computer system that is in communication with a display generation component is described. In some examples, the first computer system that is in communication with a display generation component comprises one or more processors and memory storing one or more programs configured to be executed by the one or more processors. In some examples, the one or more programs includes instructions for: in accordance with a determination that a first set of one or more criteria is satisfied while a second computer system is outputting media, wherein the first set of one or more criteria includes a criterion that is satisfied when the first computer system is determined to be within a predefined distance from a third computer system while the second computer system is outputting media: causing, the third computer system, to output the media; and changing, via the display generation component, a display location of a first representation of the media from a first location to a second location, wherein the second location corresponds to a display location of a representation of the third computer system and the first location does not correspond to a location of the display location of the first representation of the third computer system; and in accordance with a determination that a second set of one or more criteria is satisfied, wherein the second set of one or more criteria includes a criterion that is satisfied when the first computer system is determined to be within the predefined distance from the third computer system while the second computer system is outputting media: forgoing causing the third computer system to output respective media; and forgoing changing the display location of the first representation of the media from the first location to the second location.

In some examples, a first computer system that is in communication with a display generation component is described. In some examples, the first computer system that is in communication with a display generation component comprises means for performing each of the following steps: in accordance with a determination that a first set of one or more criteria is satisfied while a second computer system is outputting media, wherein the first set of one or more criteria includes a criterion that is satisfied when the first computer system is determined to be within a predefined distance from a third computer system while the second computer system is outputting media: causing, the third computer system, to output the media; and changing, via the display generation component, a display location of a first representation of the media from a first location to a second location, wherein the second location corresponds to a display location of a representation of the third computer system and the first location does not correspond to a location of the display location of the first representation of the third computer system; and in accordance with a determination that a second set of one or more criteria is satisfied, wherein the second set of one or more criteria includes a criterion that is satisfied when the first computer system is determined to be within the predefined distance from the third computer system while the second computer system is outputting media: forgoing causing the third computer system to output respective media; and forgoing changing the display location of the first representation of the media from the first location to the second location.

In some examples, a computer program product is described. In some examples, the computer program product comprises one or more programs configured to be executed by one or more processors of a first computer system that is in communication with a display generation component. In some examples, the one or more programs include instructions for: in accordance with a determination that a first set of one or more criteria is satisfied while a second computer system is outputting media, wherein the first set of one or more criteria includes a criterion that is satisfied when the first computer system is determined to be within a predefined distance from a third computer system while the second computer system is outputting media: causing, the third computer system, to output the media; and changing, via the display generation component, a display location of a first representation of the media from a first location to a second location, wherein the second location corresponds to a display location of a representation of the third computer system and the first location does not correspond to a location of the display location of the first representation of the third computer system; and in accordance with a determination that a second set of one or more criteria is satisfied, wherein the second set of one or more criteria includes a criterion that is satisfied when the first computer system is determined to be within the predefined distance from the third computer system while the second computer system is outputting media: forgoing causing the third computer system to output respective media; and forgoing changing the display location of the first representation of the media from the first location to the second location.

In some examples, a method that is performed at a computer system that is in communication with a display generation component and one or more input devices is described. In some examples, the method comprises: in accordance with a determination that a first set of one or more criteria is satisfied, wherein the first set of one or more criteria includes a criterion that is satisfied when the computer system is determined to be within a predefined distance from an external computer system, displaying, via the display generation component, a media user interface that includes: a first representation of a first media item from a first media source; and a second representation of a second media item from a second media source, wherein the second media source is different from the first media source; while displaying the media user interface, detecting, via the one or more input devices, an input that corresponds to selection of the first representation; and in response to detecting the input that corresponds to selection of the first representation, transmitting instructions to the external computer system that cause the external computer system to initiate playback of the first media item.

In some examples, a non-transitory computer-readable storage medium storing one or more programs configured to be executed by one or more processors of a computer system that is in communication with a display generation component and one or more input devices is described. In some examples, the one or more programs includes instructions for: in accordance with a determination that a first set of one or more criteria is satisfied, wherein the first set of one or more criteria includes a criterion that is satisfied when the computer system is determined to be within a predefined distance from an external computer system, displaying, via the display generation component, a media user interface that includes: a first representation of a first media item from a first media source; and a second representation of a second media item from a second media source, wherein the second media source is different from the first media source; while displaying the media user interface, detecting, via the one or more input devices, an input that corresponds to selection of the first representation; and in response to detecting the input that corresponds to selection of the first representation, transmitting instructions to the external computer system that cause the external computer system to initiate playback of the first media item.

In some examples, a transitory computer-readable storage medium storing one or more programs configured to be executed by one or more processors of a computer system that is in communication with a display generation component and one or more input devices is described. In some examples, the one or more programs includes instructions for: in accordance with a determination that a first set of one or more criteria is satisfied, wherein the first set of one or more criteria includes a criterion that is satisfied when the computer system is determined to be within a predefined distance from an external computer system, displaying, via the display generation component, a media user interface that includes: a first representation of a first media item from a first media source; and a second representation of a second media item from a second media source, wherein the second media source is different from the first media source; while displaying the media user interface, detecting, via the one or more input devices, an input that corresponds to selection of the first representation; and in response to detecting the input that corresponds to selection of the first representation, transmitting instructions to the external computer system that cause the external computer system to initiate playback of the first media item.

In some examples, a computer system that is in communication with a display generation component and one or more input devices is described. In some examples, the computer system that is in communication with a display generation component and one or more input devices comprises one or more processors and memory storing one or more programs configured to be executed by the one or more processors. In some examples, the one or more programs includes instructions for: in accordance with a determination that a first set of one or more criteria is satisfied, wherein the first set of one or more criteria includes a criterion that is satisfied when the computer system is determined to be within a predefined distance from an external computer system, displaying, via the display generation component, a media user interface that includes: a first representation of a first media item from a first media source; and a second representation of a second media item from a second media source, wherein the second media source is different from the first media source; while displaying the media user interface, detecting, via the one or more input devices, an input that corresponds to selection of the first representation; and in response to detecting the input that corresponds to selection of the first representation, transmitting instructions to the external computer system that cause the external computer system to initiate playback of the first media item.

In some examples, a computer system that is in communication with a display generation component and one or more input devices is described. In some examples, the computer system that is in communication with a display generation component and one or more input devices comprises means for performing each of the following steps: in accordance with a determination that a first set of one or more criteria is satisfied, wherein the first set of one or more criteria includes a criterion that is satisfied when the computer system is determined to be within a predefined distance from an external computer system, displaying, via the display generation component, a media user interface that includes: a first representation of a first media item from a first media source; and a second representation of a second media item from a second media source, wherein the second media source is different from the first media source; while displaying the media user interface, detecting, via the one or more input devices, an input that corresponds to selection of the first representation; and in response to detecting the input that corresponds to selection of the first representation, transmitting instructions to the external computer system that cause the external computer system to initiate playback of the first media item.

In some examples, a computer program product is described. In some examples, the computer program product comprises one or more programs configured to be executed by one or more processors of a computer system that is in communication with a display generation component and one or more input devices. In some examples, the one or more programs include instructions for: in accordance with a determination that a first set of one or more criteria is satisfied, wherein the first set of one or more criteria includes a criterion that is satisfied when the computer system is determined to be within a predefined distance from an external computer system, displaying, via the display generation component, a media user interface that includes: a first representation of a first media item from a first media source; and a second representation of a second media item from a second media source, wherein the second media source is different from the first media source; while displaying the media user interface, detecting, via the one or more input devices, an input that corresponds to selection of the first representation; and in response to detecting the input that corresponds to selection of the first representation, transmitting instructions to the external computer system that cause the external computer system to initiate playback of the first media item.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

Thus, devices are provided with faster, more efficient methods and interfaces for managing the playback of media, thereby increasing the effectiveness, efficiency, and user satisfaction with such devices. Such methods and interfaces may complement or replace other methods for managing the playback of media.

### DESCRIPTION OF THE FIGURES

For a better understanding of the various described embodiments, reference should be made to the Detailed Description below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3 is a block diagram of an exemplary multifunction device with a display and a touch-sensitive surface in accordance with some embodiments.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIGS. 5C-5D illustrate exemplary components of a personal electronic device having a touch-sensitive display and intensity sensors in accordance with some embodiments.

FIGS. 5E-5H illustrate exemplary components and user interfaces of a personal electronic device in accordance with some embodiments.

FIG. 5I illustrates an electronic device in accordance with some embodiments.

FIG. 5J is a block diagram illustrating an electronic device in accordance with some embodiments.

FIGS. 6A-6X illustrate exemplary user interfaces for managing the playback of media in accordance with some embodiments.

FIG. 7 is a flow diagram illustrating a method for managing the playback of media in accordance with some embodiments.

FIG. 8 is a flow diagram illustrating a method of managing the playback of recently played media in accordance with some embodiments.

### DETAILED DESCRIPTION

The following description sets forth exemplary methods, parameters, and the like. It should be recognized, however, that such description is not intended as a limitation on the scope of the present disclosure but is instead provided as a description of exemplary embodiments.

There is a need for electronic devices that provide efficient methods and interfaces for managing the playback of media. For example, the playback of media can be managed based on the proximity between electronic devices. Such techniques can reduce the cognitive burden on a user who manages the playback of media, thereby enhancing productivity. Further, such techniques can reduce processor and battery power otherwise wasted on redundant user inputs.

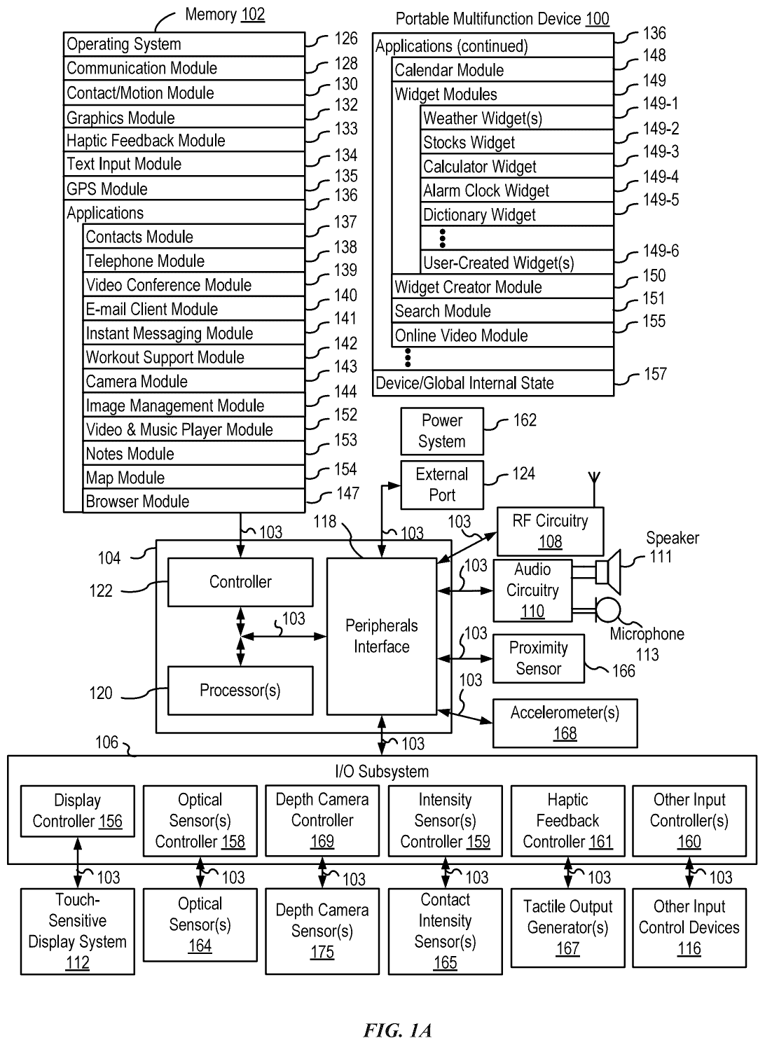

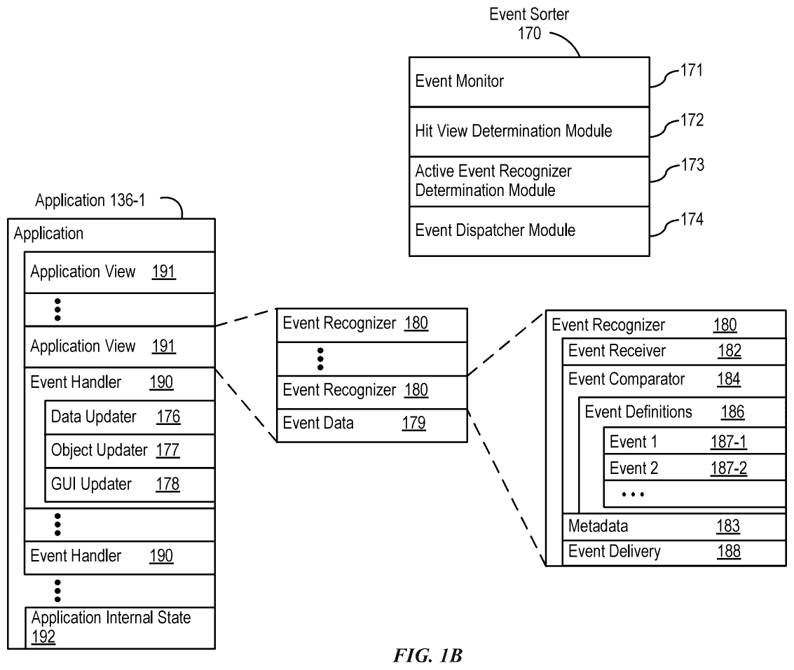

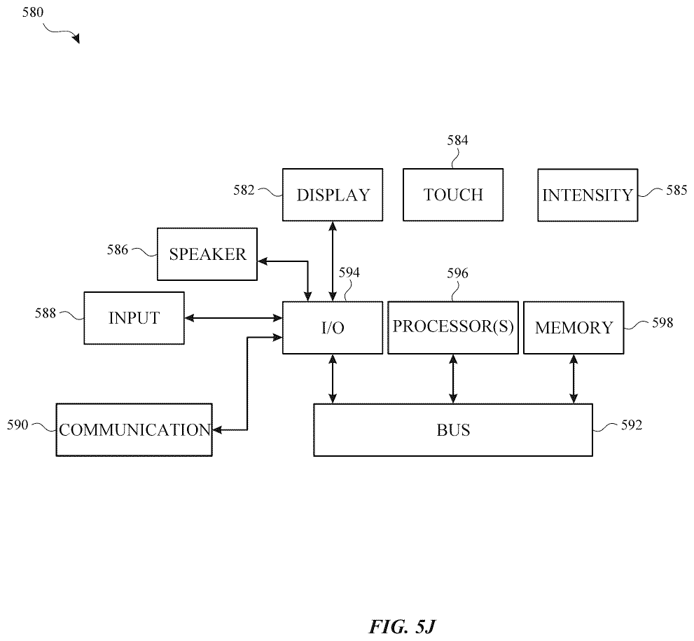

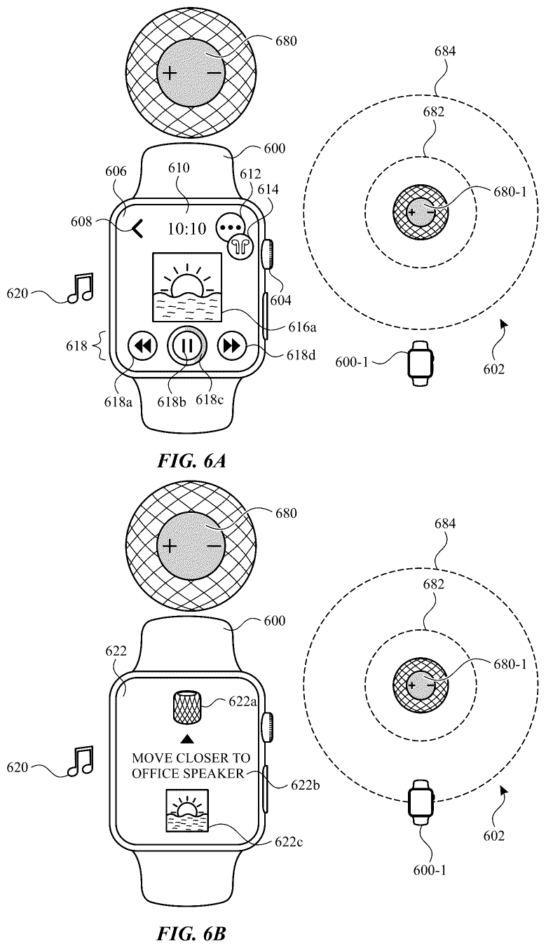

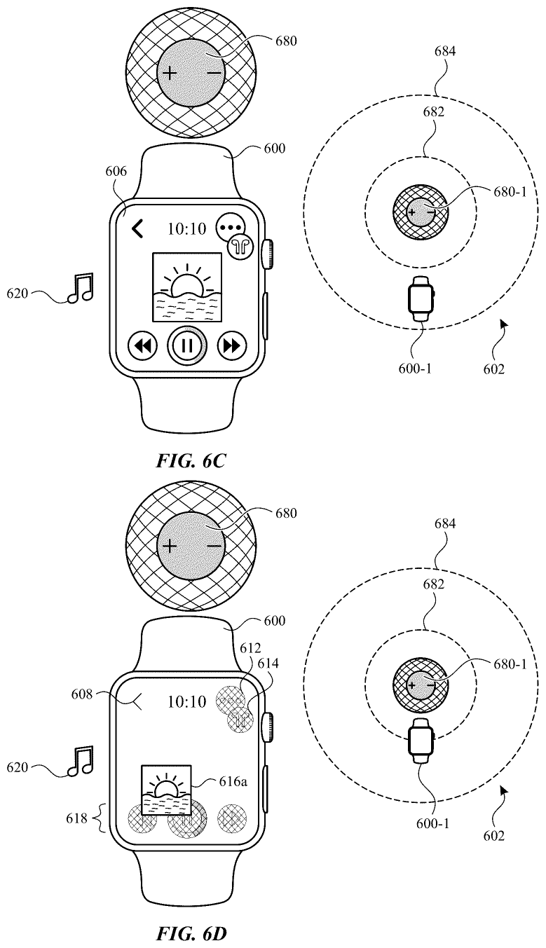

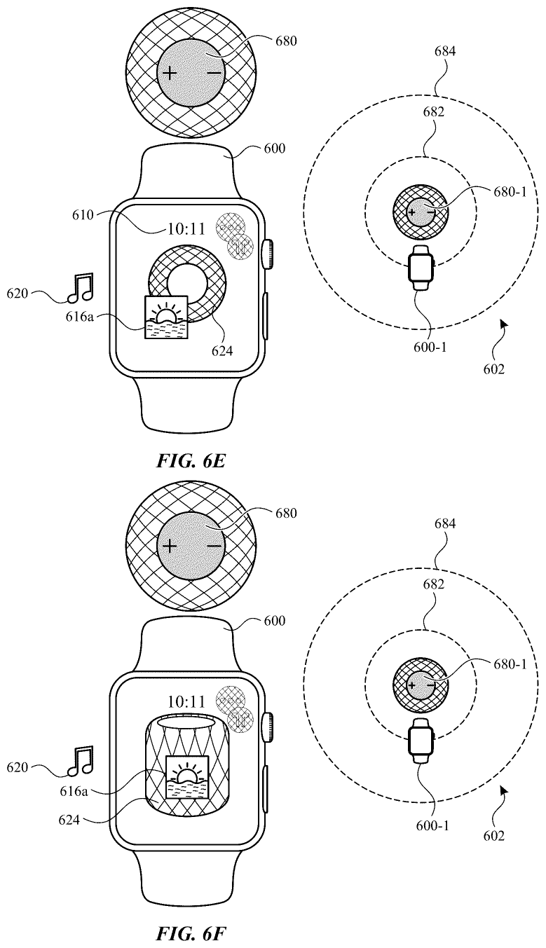

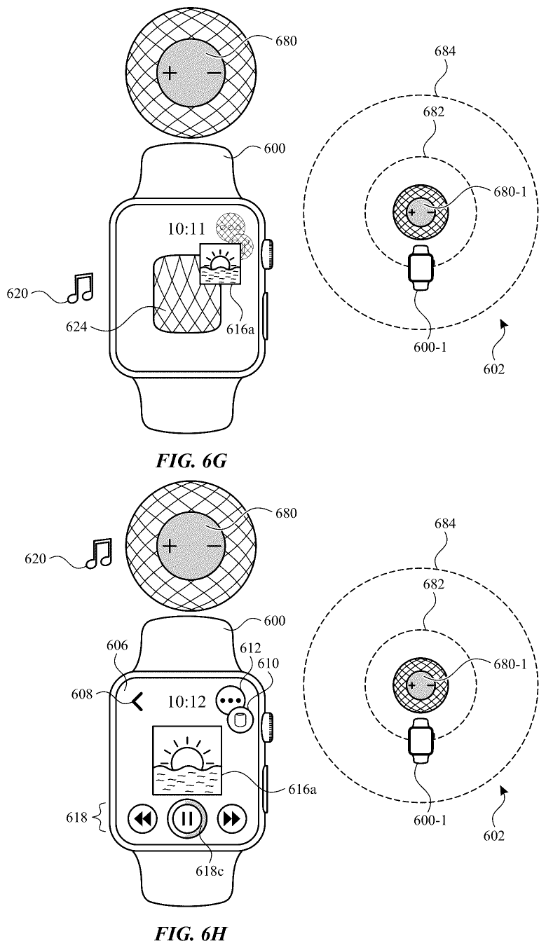

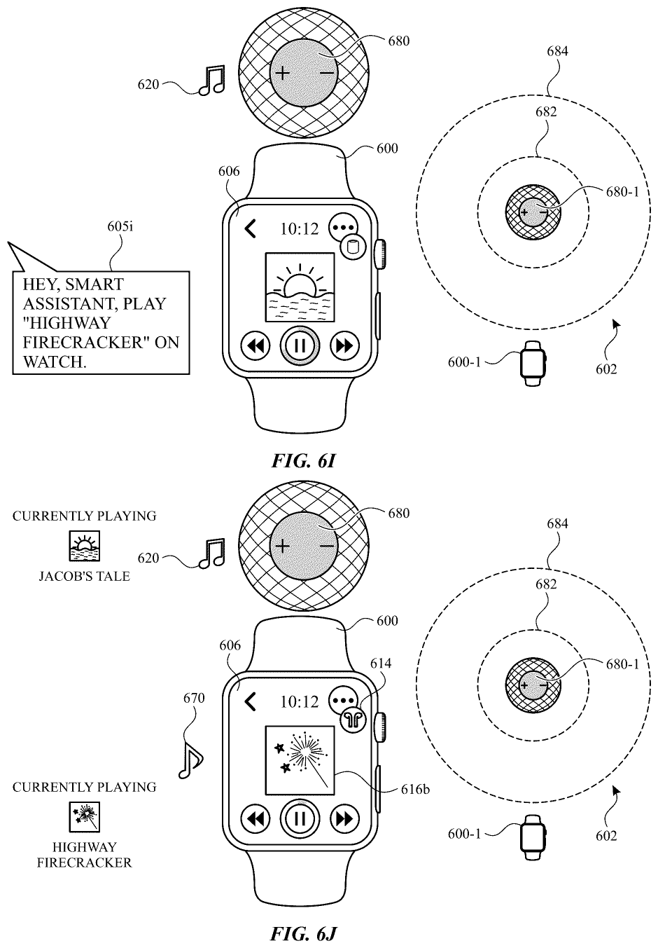

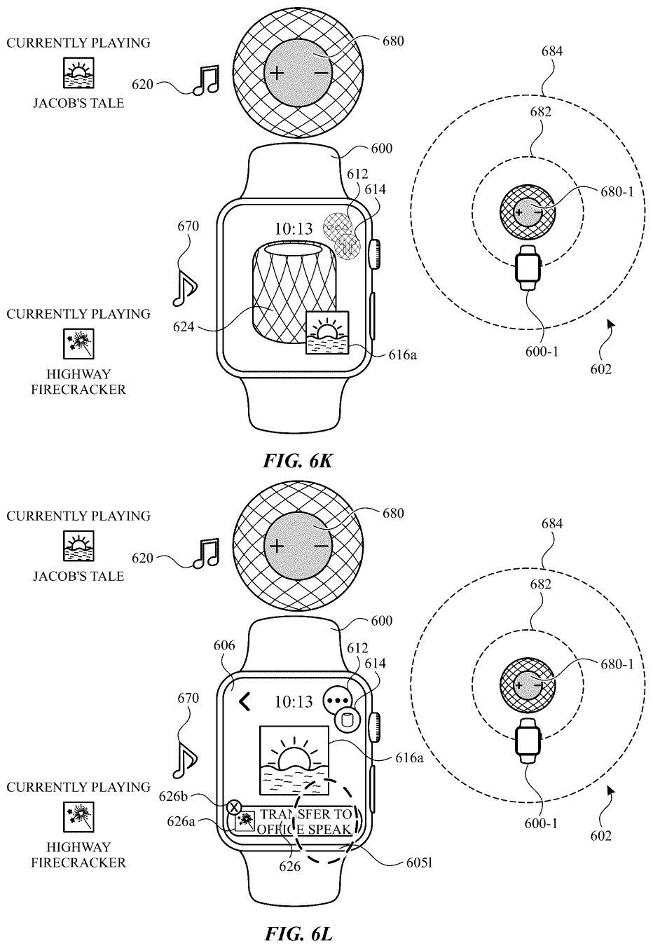

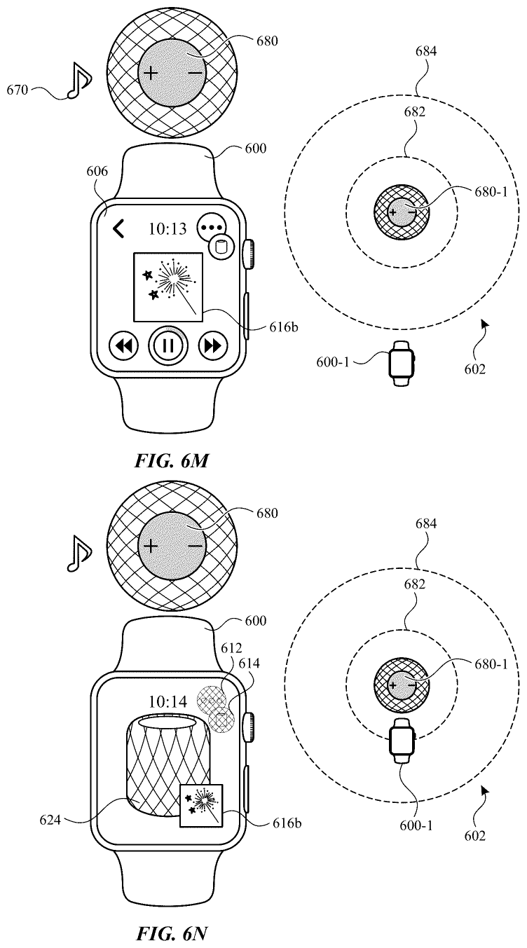

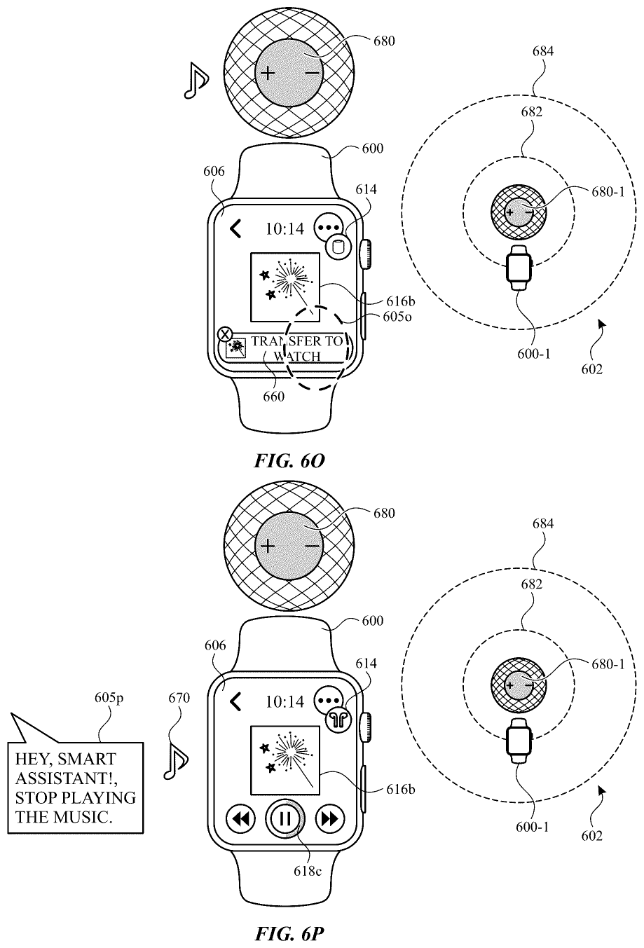

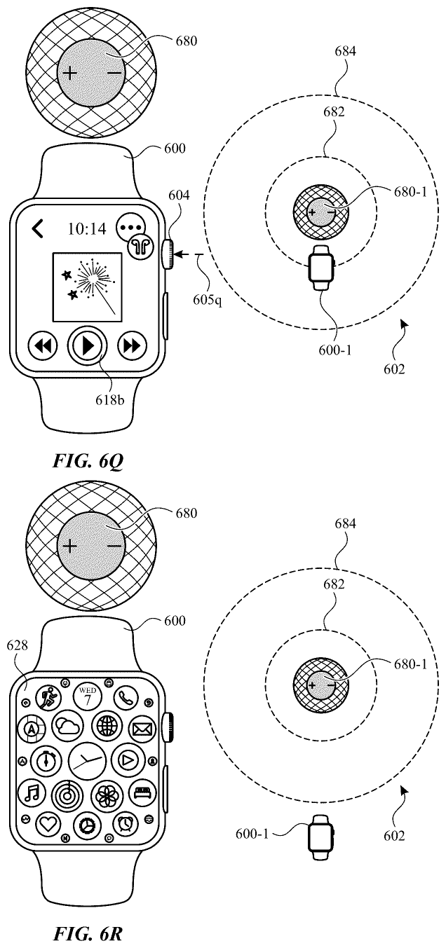

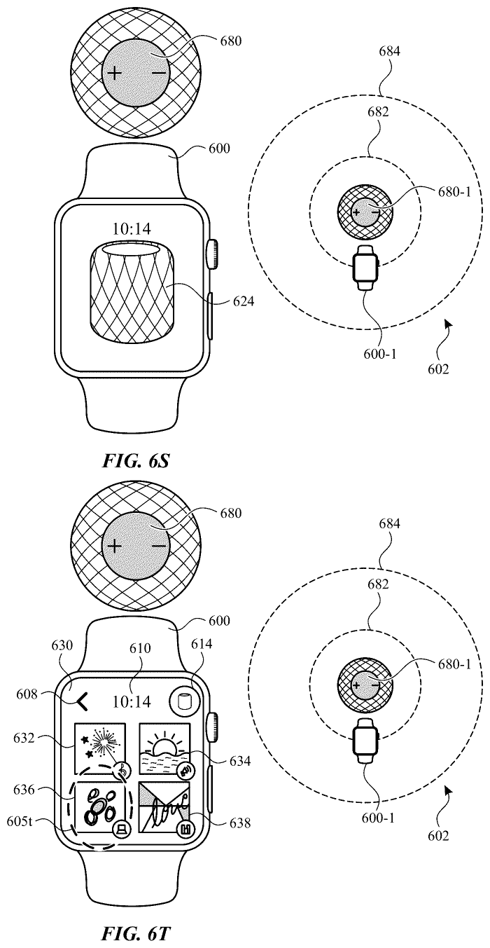

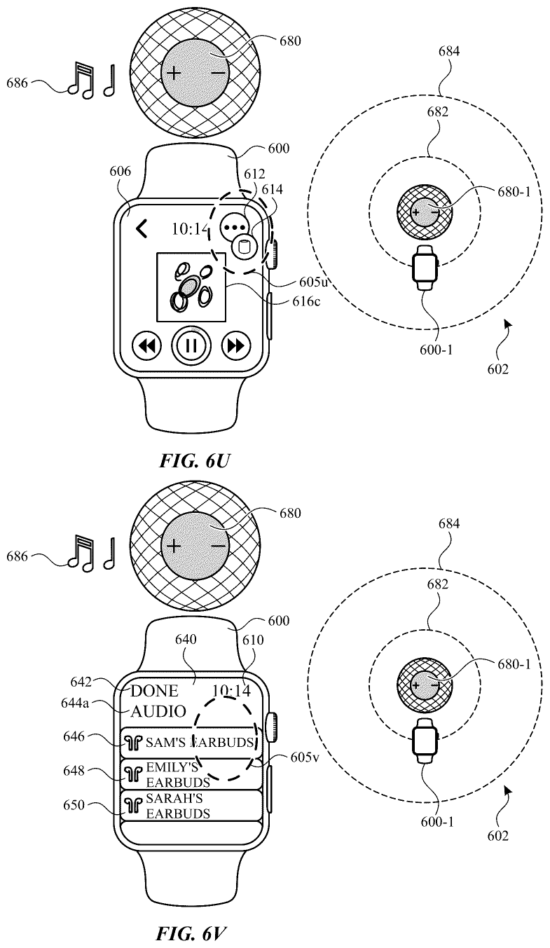

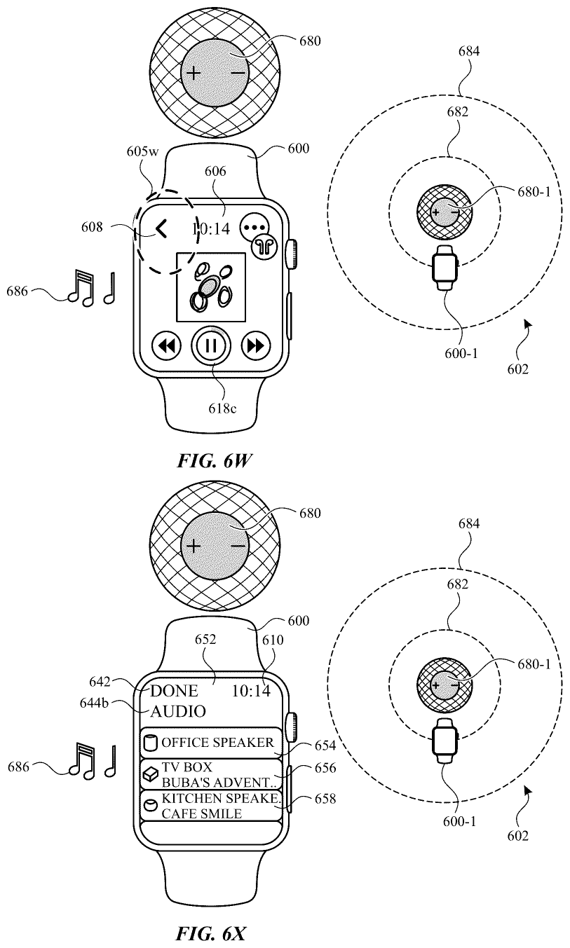

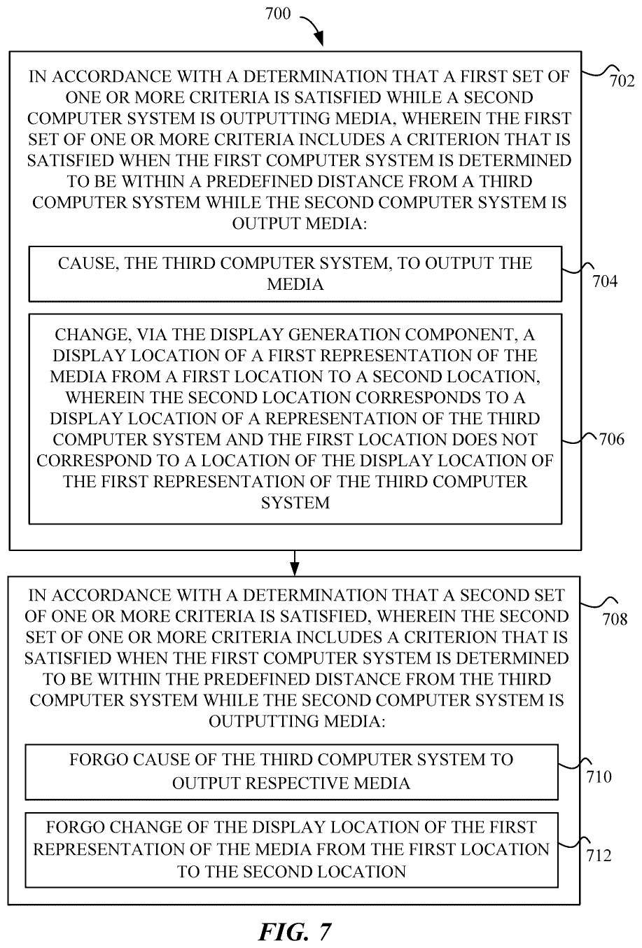

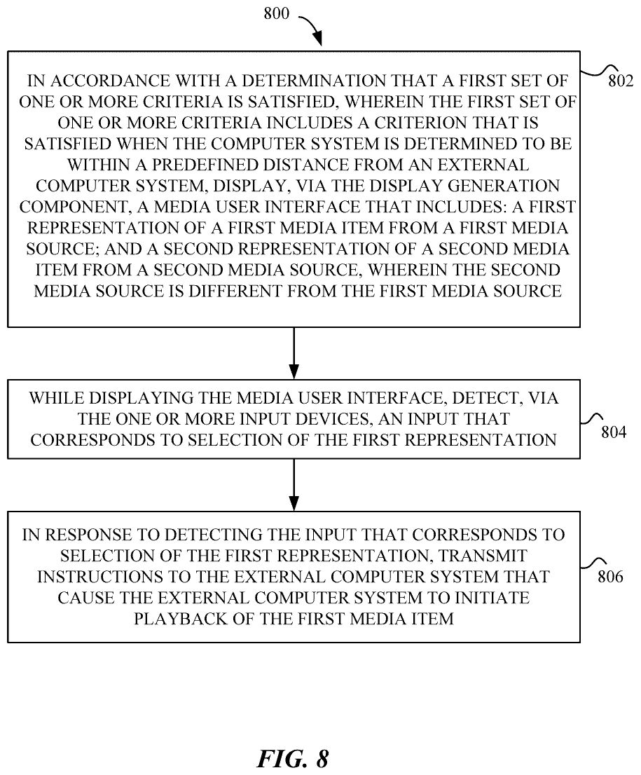

Below, FIGS. 1A-1B, 2, 3, 4A-4B, and 5A-5J provide a description of exemplary devices for performing the techniques for managing the playback of media. FIGS. 6A-6X illustrate exemplary user interfaces for managing the playback of media in accordance with some embodiments. FIG. 7 is a flow diagram illustrating methods of managing the playback of media in accordance with some embodiments. FIG. 8 is a flow diagram illustrating methods of managing the playback of recently played media in accordance with some embodiments. The user interfaces in FIGS. 6A-6X are used to illustrate the processes described below, including the processes in FIGS. 7 and 8.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, and/or additional techniques. These techniques also reduce power usage and improve battery life of the device by enabling the user to use the device more quickly and efficiently.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

Although the following description uses terms “first,” “second,” etc. to describe various elements, these elements should not be limited by the terms. In some embodiments, these terms are used to distinguish one element from another. For example, a first touch could be termed a second touch, and, similarly, a second touch could be termed a first touch, without departing from the scope of the various described embodiments. In some embodiments, the first touch and the second touch are two separate references to the same touch. In some embodiments, the first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer with a touch-sensitive surface (e.g., a touch screen display and/or a touchpad). In some embodiments, the electronic device is a computer system that is in communication (e.g., via wireless communication, via wired communication) with a display generation component. The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse, and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display 112 is sometimes called a “touch screen” for convenience and is sometimes known as or called a “touch-sensitive display system.” Device 100 includes memory 102 (which optionally includes one or more computer-readable storage mediums), memory controller 122, one or more processing units (CPUs) 120, peripherals interface 118, RF circuitry 108, audio circuitry 110, speaker 111, microphone 113, input/output (I/O) subsystem 106, other input control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application-specific integrated circuits.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs (such as computer programs (e.g., including instructions)) and/or sets of instructions stored in memory 102 to perform various functions for device 100 and to process data. In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VoIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

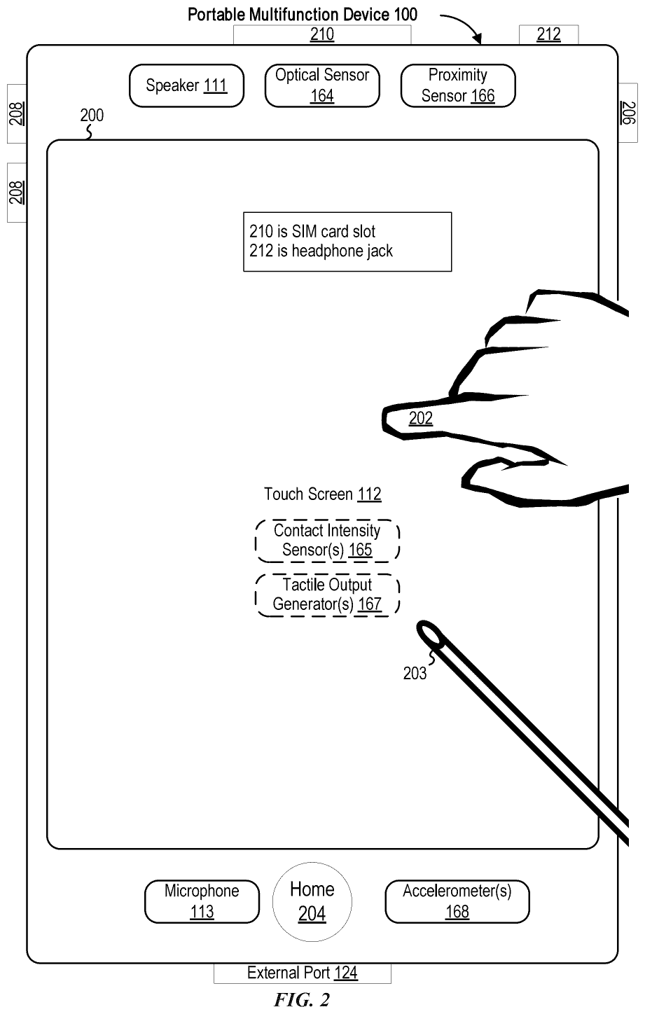

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, depth camera controller 169, intensity sensor controller 159, haptic feedback controller 161, and one or more input controllers 160 for other input or control devices. The one or more input controllers 160 receive/send electrical signals from/to other input control devices 116. The other input control devices 116 optionally include physical buttons (e.g., push buttons, rocker buttons, etc.), dials, slider switches, joysticks, click wheels, and so forth. In some embodiments, input controller(s) 160 are, optionally, coupled to any (or none) of the following: a keyboard, an infrared port, a USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2). In some embodiments, the electronic device is a computer system that is in communication (e.g., via wireless communication, via wired communication) with one or more input devices. In some embodiments, the one or more input devices include a touch-sensitive surface (e.g., a trackpad, as part of a touch-sensitive display). In some embodiments, the one or more input devices include one or more camera sensors (e.g., one or more optical sensors 164 and/or one or more depth camera sensors 175), such as for tracking a user's gestures (e.g., hand gestures and/or air gestures) as input. In some embodiments, the one or more input devices are integrated with the computer system. In some embodiments, the one or more input devices are separate from the computer system. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output optionally corresponds to user-interface objects.

Touch screen 112 has a touch-sensitive surface, sensor, or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, California.

A touch-sensitive display in some embodiments of touch screen 112 is, optionally, analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more depth camera sensors 175. FIG. 1A shows a depth camera sensor coupled to depth camera controller 169 in I/O subsystem 106. Depth camera sensor 175 receives data from the environment to create a three dimensional model of an object (e.g., a face) within a scene from a viewpoint (e.g., a depth camera sensor). In some embodiments, in conjunction with imaging module 143 (also called a camera module), depth camera sensor 175 is optionally used to determine a depth map of different portions of an image captured by the imaging module 143. In some embodiments, a depth camera sensor is located on the front of device 100 so that the user's image with depth information is, optionally, obtained for video conferencing while the user views the other video conference participants on the touch screen display and to capture selfies with depth map data. In some embodiments, the depth camera sensor 175 is located on the back of device, or on the back and the front of the device 100. In some embodiments, the position of depth camera sensor 175 can be changed by the user (e.g., by rotating the lens and the sensor in the device housing) so that a depth camera sensor 175 is used along with the touch screen display for both video conferencing and still and/or video image acquisition.

In some embodiments, a depth map (e.g., depth map image) contains information (e.g., values) that relates to the distance of objects in a scene from a viewpoint (e.g., a camera, an optical sensor, a depth camera sensor). In one embodiment of a depth map, each depth pixel defines the position in the viewpoint's Z-axis where its corresponding two-dimensional pixel is located. In some embodiments, a depth map is composed of pixels wherein each pixel is defined by a value (e.g., 0-255). For example, the “0” value represents pixels that are located at the most distant place in a “three dimensional” scene and the “255” value represents pixels that are located closest to a viewpoint (e.g., a camera, an optical sensor, a depth camera sensor) in the “three dimensional” scene. In other embodiments, a depth map represents the distance between an object in a scene and the plane of the viewpoint. In some embodiments, the depth map includes information about the relative depth of various features of an object of interest in view of the depth camera (e.g., the relative depth of eyes, nose, mouth, ears of a user's face). In some embodiments, the depth map includes information that enables the device to determine contours of the object of interest in a z direction.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112, which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112, which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

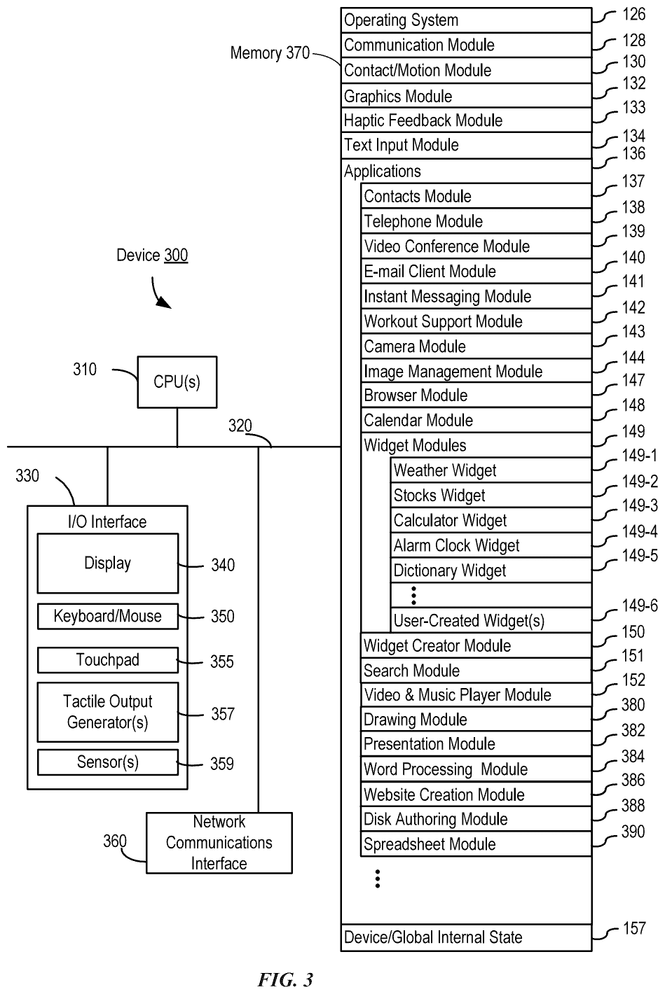

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments, memory 102 (FIG. 1A) or 370 (FIG. 3) stores device/global internal state 157, as shown in FIGS. 1A and 3. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, iOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts 137, e-mail 140, IM 141, browser 147, and any other application that needs text input).

GPS module 135 determines the location of the device and provides this information for use in various applications (e.g., to telephone 138 for use in location-based dialing; to camera 143 as picture/video metadata; and to applications that provide location-based services such as weather widgets, local yellow page widgets, and map/navigation widgets).

Applications 136 optionally include the following modules (or sets of instructions), or a subset or superset thereof:
Contacts module 137 (sometimes called an address book or contact list);
Telephone module 138;
Video conference module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search module 151;
Video and music player module 152, which merges video player module and music player module;
Notes module 153;
Map module 154; and/or
Online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 138, video conference module 139, e-mail 140, or IM 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo!Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs (such as computer programs (e.g., including instructions)), procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (e.g., 187-1 and/or 187-2) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definitions 186 include a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also include one or more physical buttons, such as “home” or menu button 204. As described previously, menu button 204 is, optionally, used to navigate to any application 136 in a set of applications that are, optionally, executed on device 100. Alternatively, in some embodiments, the menu button is implemented as a soft key in a GUI displayed on touch screen 112.

In some embodiments, device 100 includes touch screen 112, menu button 204, push button 206 for powering the device on/off and locking the device, volume adjustment button(s) 208, subscriber identity module (SIM) card slot 210, headset jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3 is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPUs) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above-identified elements in FIG. 3 is, optionally, stored in one or more of the previously mentioned memory devices. Each of the above-identified modules corresponds to a set of instructions for performing a function described above. The above-identified modules or computer programs (e.g., sets of instructions or including instructions) need not be implemented as separate software programs (such as computer programs (e.g., including instructions)), procedures, or modules, and thus various subsets of these modules are, optionally, combined or otherwise rearranged in various embodiments. In some embodiments, memory 370 optionally stores a subset of the modules and data structures identified above. Furthermore, memory 370 optionally stores additional modules and data structures not described above.

Attention is now directed towards embodiments of user interfaces that are, optionally, implemented on, for example, portable multifunction device 100.

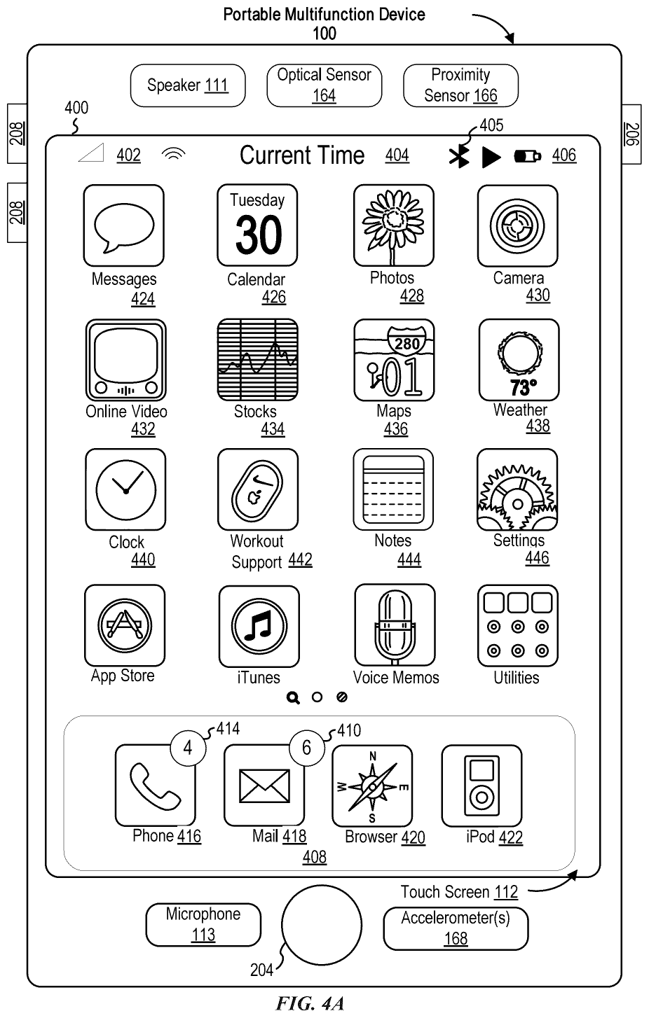

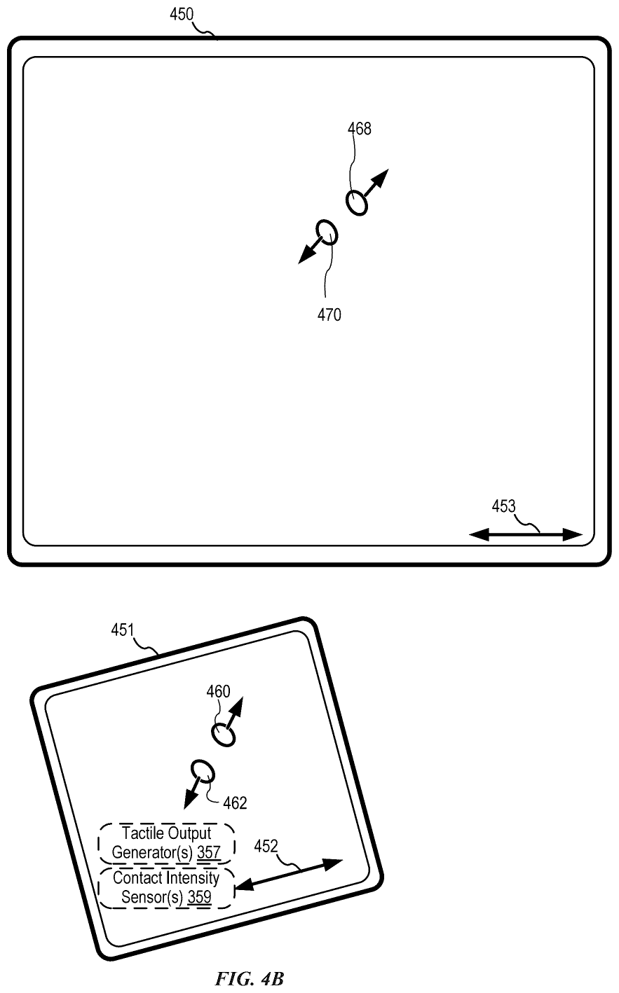

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3) with a touch-sensitive surface 451 (e.g., a tablet or touchpad 355, FIG. 3) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

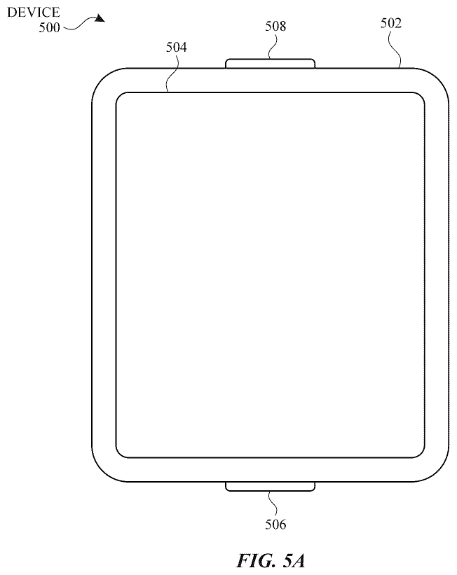

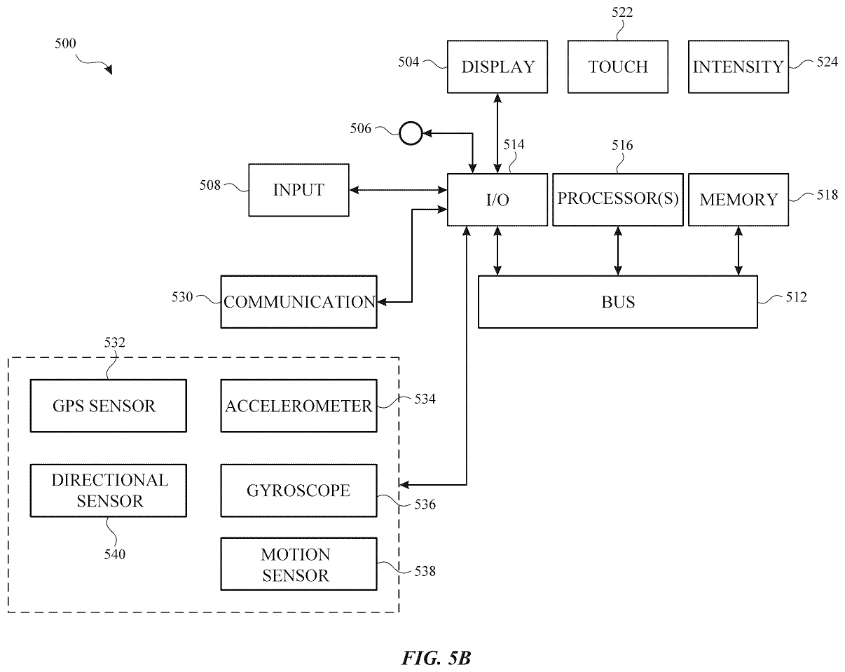

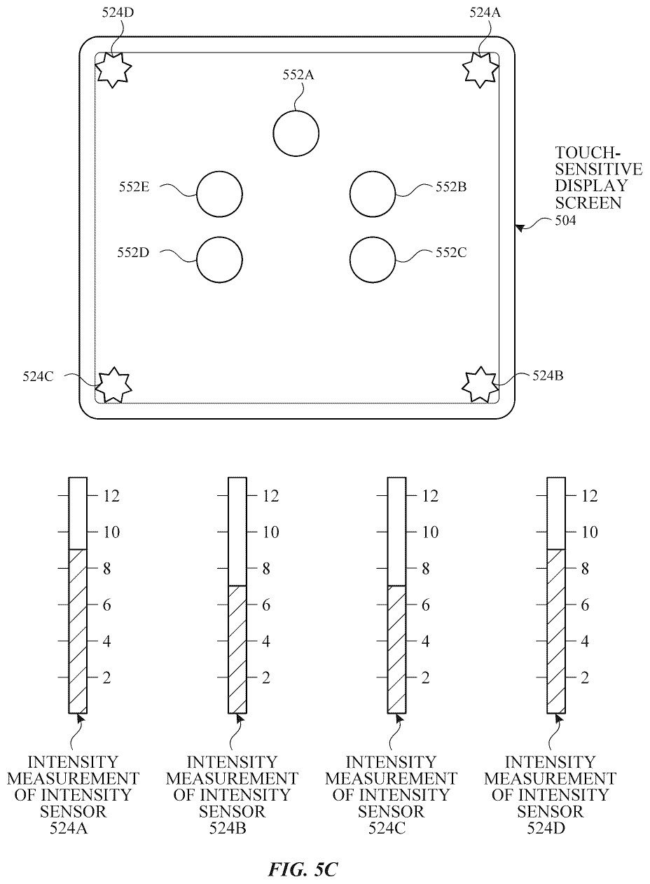

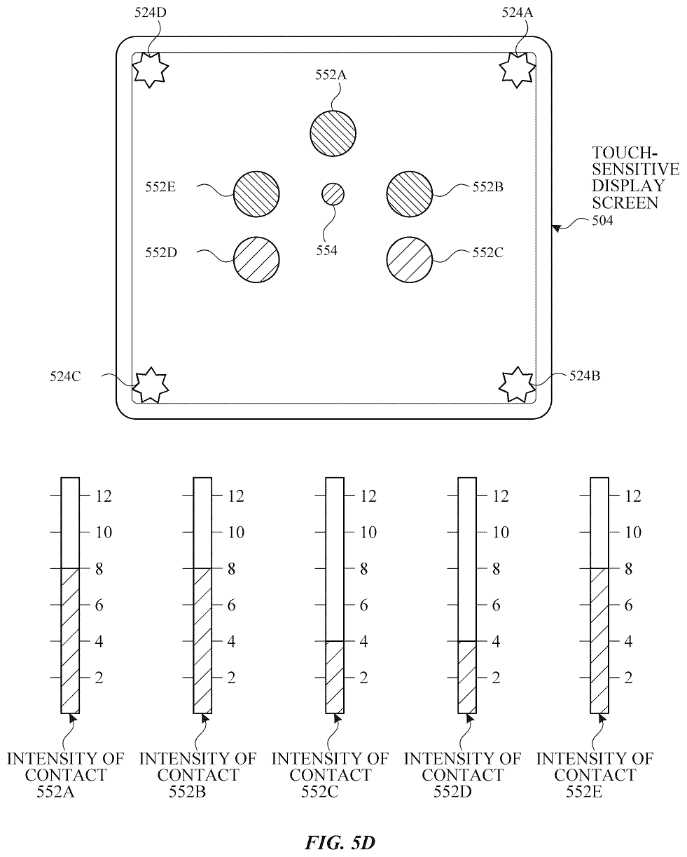

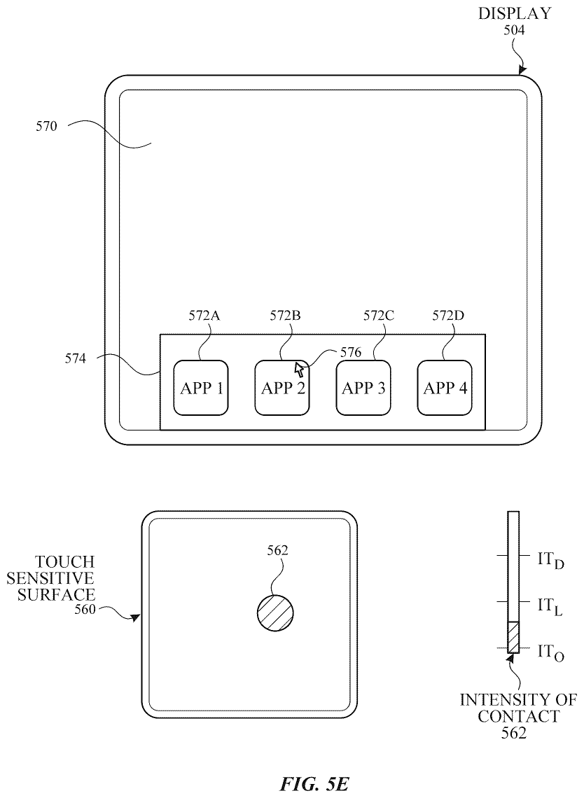

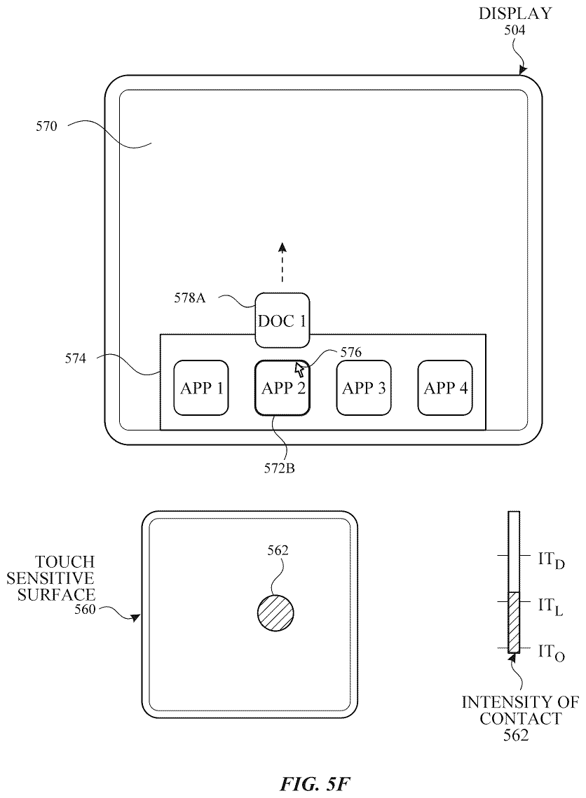

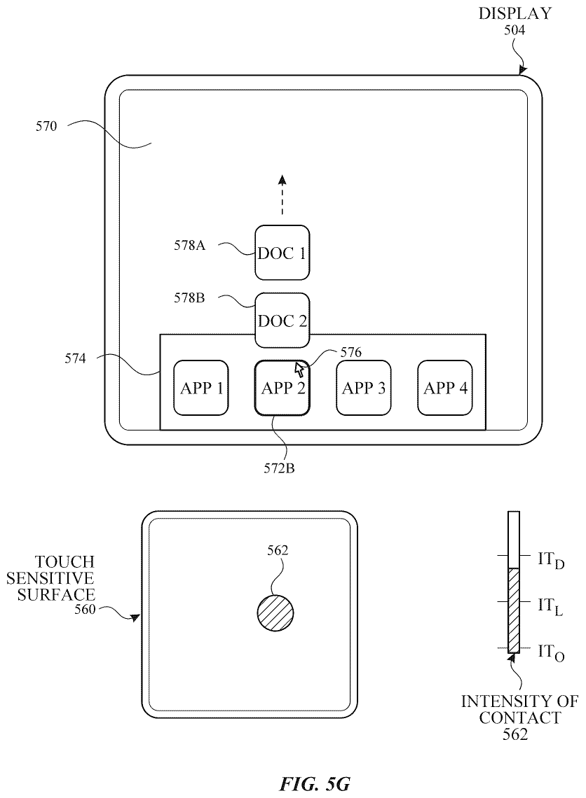

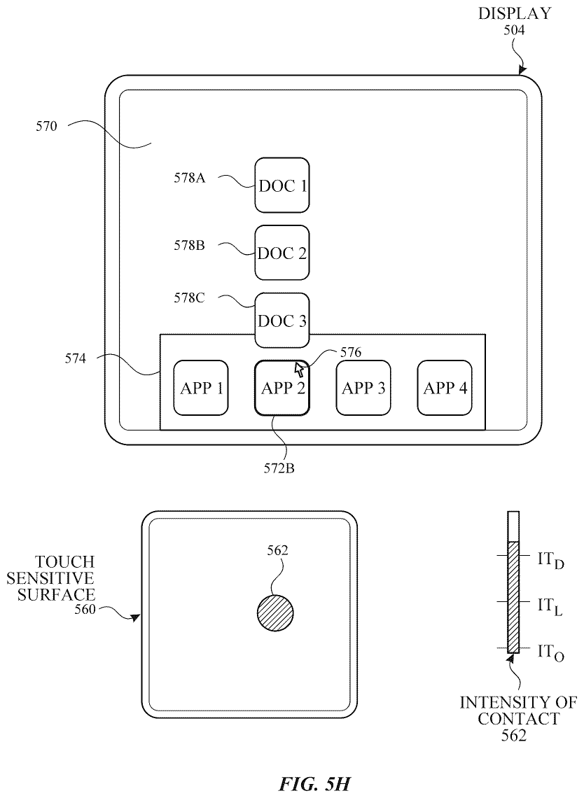

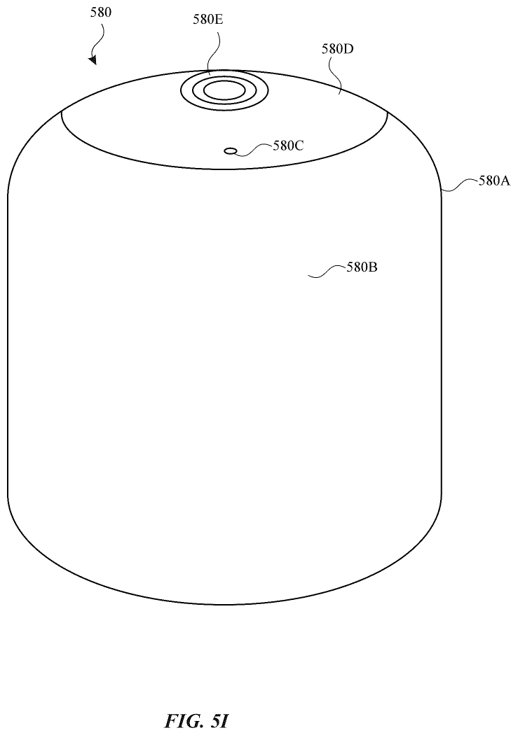

FIG. 5A illustrates exemplary personal electronic device 500. Device 500 includes body 502. In some embodiments, device 500 can include some or all of the features described with respect to devices 100 and 300 (e.g., FIGS. 1A-4B). In some embodiments, device 500 has touch-sensitive display screen 504, hereafter touch screen 504. Alternatively, or in addition to touch screen 504, device 500 has a display and a touch-sensitive surface. As with devices 100 and 300, in some embodiments, touch screen 504 (or the touch-sensitive surface) optionally includes one or more intensity sensors for detecting intensity of contacts (e.g., touches) being applied. The one or more intensity sensors of touch screen 504 (or the touch-sensitive surface) can provide output data that represents the intensity of touches. The user interface of device 500 can respond to touches based on their intensity, meaning that touches of different intensities can invoke different user interface operations on device 500.

Exemplary techniques for detecting and processing touch intensity are found, for example, in related applications: International Patent Application Serial No. PCT/US2013/040061, titled “Device, Method, and Graphical User Interface for Displaying User Interface Objects Corresponding to an Application,” filed May 8, 2013, published as WIPO Publication No. WO/2013/169849, and International Patent Application Serial No. PCT/US2013/069483, titled “Device, Method, and Graphical User Interface for Transitioning Between Touch Input to Display Output Relationships,” filed Nov. 11, 2013, published as WIPO Publication No. WO/2014/105276, each of which is hereby incorporated by reference in their entirety.

In some embodiments, device 500 has one or more input mechanisms 506 and 508. Input mechanisms 506 and 508, if included, can be physical. Examples of physical input mechanisms include push buttons and rotatable mechanisms. In some embodiments, device 500 has one or more attachment mechanisms. Such attachment mechanisms, if included, can permit attachment of device 500 with, for example, hats, eyewear, earrings, necklaces, shirts, jackets, bracelets, watch straps, chains, trousers, belts, shoes, purses, backpacks, and so forth. These attachment mechanisms permit device 500 to be worn by a user.

FIG. 5B depicts exemplary personal electronic device 500. In some embodiments, device 500 can include some or all of the components described with respect to FIGS. 1A, 1B, and 3. Device 500 has bus 512 that operatively couples I/O section 514 with one or more computer processors 516 and memory 518. I/O section 514 can be connected to display 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques. Device 500 can include input mechanisms 506 and/or 508. Input mechanism 506 is, optionally, a rotatable input device, for example. Input mechanism 508 is, optionally, a button, in some examples.

Input mechanism 508 is, optionally, a microphone, in some examples. Personal electronic device 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

Memory 518 of personal electronic device 500 can include one or more non-transitory computer-readable storage mediums, for storing computer-executable instructions, which, when executed by one or more computer processors 516, for example, can cause the computer processors to perform the techniques described below, including processes 700 and 800 (FIGS. 7 and 8). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIG. 5B, but can include other or additional components in multiple configurations.

As used here, the term “affordance” refers to a user-interactive graphical user interface object that is, optionally, displayed on the display screen of devices 100, 300, and/or 500 (FIGS. 1A, 3, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3 or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

FIG. 5C illustrates detecting a plurality of contacts 552A-552E on touch-sensitive display screen 504 with a plurality of intensity sensors 524A-524D. FIG. 5C additionally includes intensity diagrams that show the current intensity measurements of the intensity sensors 524A-524D relative to units of intensity. In this example, the intensity measurements of intensity sensors 524A and 524D are each 9 units of intensity, and the intensity measurements of intensity sensors 524B and 524C are each 7 units of intensity. In some implementations, an aggregate intensity is the sum of the intensity measurements of the plurality of intensity sensors 524A-524D, which in this example is 32 intensity units. In some embodiments, each contact is assigned a respective intensity that is a portion of the aggregate intensity. FIG. 5D illustrates assigning the aggregate intensity to contacts 552A-552E based on their distance from the center of force 554. In this example, each of contacts 552A, 552B, and 552E are assigned an intensity of contact of 8 intensity units of the aggregate intensity, and each of contacts 552C and 552D are assigned an intensity of contact of 4 intensity units of the aggregate intensity. More generally, in some implementations, each contact j is assigned a respective intensity Ij that is a portion of the aggregate intensity, A, in accordance with a predefined mathematical function, Ij=A (Dj/EDi), where Dj is the distance of the respective contact j to the center of force, and ΣDi is the sum of the distances of all the respective contacts (e.g., i=1 to last) to the center of force. The operations described with reference to FIGS. 5C-5D can be performed using an electronic device similar or identical to device 100, 300, or 500. In some embodiments, a characteristic intensity of a contact is based on one or more intensities of the contact. In some embodiments, the intensity sensors are used to determine a single characteristic intensity (e.g., a single characteristic intensity of a single contact). It should be noted that the intensity diagrams are not part of a displayed user interface, but are included in FIGS. 5C-5D to aid the reader.

In some embodiments, a portion of a gesture is identified for purposes of determining a characteristic intensity. For example, a touch-sensitive surface optionally receives a continuous swipe contact transitioning from a start location and reaching an end location, at which point the intensity of the contact increases. In this example, the characteristic intensity of the contact at the end location is, optionally, based on only a portion of the continuous swipe contact, and not the entire swipe contact (e.g., only the portion of the swipe contact at the end location). In some embodiments, a smoothing algorithm is, optionally, applied to the intensities of the swipe contact prior to determining the characteristic intensity of the contact. For example, the smoothing algorithm optionally includes one or more of: an unweighted sliding-average smoothing algorithm, a triangular smoothing algorithm, a median filter smoothing algorithm, and/or an exponential smoothing algorithm. In some circumstances, these smoothing algorithms eliminate narrow spikes or dips in the intensities of the swipe contact for purposes of determining a characteristic intensity.

The intensity of a contact on the touch-sensitive surface is, optionally, characterized relative to one or more intensity thresholds, such as a contact-detection intensity threshold, a light press intensity threshold, a deep press intensity threshold, and/or one or more other intensity thresholds. In some embodiments, the light press intensity threshold corresponds to an intensity at which the device will perform operations typically associated with clicking a button of a physical mouse or a trackpad. In some embodiments, the deep press intensity threshold corresponds to an intensity at which the device will perform operations that are different from operations typically associated with clicking a button of a physical mouse or a trackpad. In some embodiments, when a contact is detected with a characteristic intensity below the light press intensity threshold (e.g., and above a nominal contact-detection intensity threshold below which the contact is no longer detected), the device will move a focus selector in accordance with movement of the contact on the touch-sensitive surface without performing an operation associated with the light press intensity threshold or the deep press intensity threshold. Generally, unless otherwise stated, these intensity thresholds are consistent between different sets of user interface figures.

An increase of characteristic intensity of the contact from an intensity below the light press intensity threshold to an intensity between the light press intensity threshold and the deep press intensity threshold is sometimes referred to as a “light press” input. An increase of characteristic intensity of the contact from an intensity below the deep press intensity threshold to an intensity above the deep press intensity threshold is sometimes referred to as a “deep press” input. An increase of characteristic intensity of the contact from an intensity below the contact-detection intensity threshold to an intensity between the contact-detection intensity threshold and the light press intensity threshold is sometimes referred to as detecting the contact on the touch-surface. A decrease of characteristic intensity of the contact from an intensity above the contact-detection intensity threshold to an intensity below the contact-detection intensity threshold is sometimes referred to as detecting liftoff of the contact from the touch-surface. In some embodiments, the contact-detection intensity threshold is zero. In some embodiments, the contact-detection intensity threshold is greater than zero.

In some embodiments described herein, one or more operations are performed in response to detecting a gesture that includes a respective press input or in response to detecting the respective press input performed with a respective contact (or a plurality of contacts), where the respective press input is detected based at least in part on detecting an increase in intensity of the contact (or plurality of contacts) above a press-input intensity threshold. In some embodiments, the respective operation is performed in response to detecting the increase in intensity of the respective contact above the press-input intensity threshold (e.g., a “down stroke” of the respective press input). In some embodiments, the press input includes an increase in intensity of the respective contact above the press-input intensity threshold and a subsequent decrease in intensity of the contact below the press-input intensity threshold, and the respective operation is performed in response to detecting the subsequent decrease in intensity of the respective contact below the press-input threshold (e.g., an “up stroke” of the respective press input).

FIGS. 5E-5H illustrate detection of a gesture that includes a press input that corresponds to an increase in intensity of a contact 562 from an intensity below a light press intensity threshold (e.g., “IT_{L}”) in FIG. 5E, to an intensity above a deep press intensity threshold (e.g., “IT_{D}”) in FIG. 5H. The gesture performed with contact 562 is detected on touch-sensitive surface 560 while cursor 576 is displayed over application icon 572B corresponding to App 2, on a displayed user interface 570 that includes application icons 572A-572D displayed in predefined region 574. In some embodiments, the gesture is detected on touch-sensitive display 504. The intensity sensors detect the intensity of contacts on touch-sensitive surface 560. The device determines that the intensity of contact 562 peaked above the deep press intensity threshold (e.g., “IT_{D}”). Contact 562 is maintained on touch-sensitive surface 560. In response to the detection of the gesture, and in accordance with contact 562 having an intensity that goes above the deep press intensity threshold (e.g., “IT_{D}”) during the gesture, reduced-scale representations 578A-578C (e.g., thumbnails) of recently opened documents for App 2 are displayed, as shown in FIGS. 5F-5H. In some embodiments, the intensity, which is compared to the one or more intensity thresholds, is the characteristic intensity of a contact. It should be noted that the intensity diagram for contact 562 is not part of a displayed user interface, but is included in FIGS. 5E-5H to aid the reader.

In some embodiments, the display of representations 578A-578C includes an animation. For example, representation 578A is initially displayed in proximity of application icon 572B, as shown in FIG. 5F. As the animation proceeds, representation 578A moves upward and representation 578B is displayed in proximity of application icon 572B, as shown in FIG. 5G. Then, representations 578A moves upward, 578B moves upward toward representation 578A, and representation 578C is displayed in proximity of application icon 572B, as shown in FIG. 5H. Representations 578A-578C form an array above icon 572B. In some embodiments, the animation progresses in accordance with an intensity of contact 562, as shown in FIGS. 5F-5G, where the representations 578A-578C appear and move upwards as the intensity of contact 562 increases toward the deep press intensity threshold (e.g., “IT_{D}”). In some embodiments, the intensity, on which the progress of the animation is based, is the characteristic intensity of the contact. The operations described with reference to FIGS. 5E-5H can be performed using an electronic device similar or identical to device 100, 300, or 500.

In some embodiments, the device employs intensity hysteresis to avoid accidental inputs sometimes termed “jitter,” where the device defines or selects a hysteresis intensity threshold with a predefined relationship to the press-input intensity threshold (e.g., the hysteresis intensity threshold is X intensity units lower than the press-input intensity threshold or the hysteresis intensity threshold is 75%, 90%, or some reasonable proportion of the press-input intensity threshold). Thus, in some embodiments, the press input includes an increase in intensity of the respective contact above the press-input intensity threshold and a subsequent decrease in intensity of the contact below the hysteresis intensity threshold that corresponds to the press-input intensity threshold, and the respective operation is performed in response to detecting the subsequent decrease in intensity of the respective contact below the hysteresis intensity threshold (e.g., an “up stroke” of the respective press input). Similarly, in some embodiments, the press input is detected only when the device detects an increase in intensity of the contact from an intensity at or below the hysteresis intensity threshold to an intensity at or above the press-input intensity threshold and, optionally, a subsequent decrease in intensity of the contact to an intensity at or below the hysteresis intensity, and the respective operation is performed in response to detecting the press input (e.g., the increase in intensity of the contact or the decrease in intensity of the contact, depending on the circumstances).

For ease of explanation, the descriptions of operations performed in response to a press input associated with a press-input intensity threshold or in response to a gesture including the press input are, optionally, triggered in response to detecting either: an increase in intensity of a contact above the press-input intensity threshold, an increase in intensity of a contact from an intensity below the hysteresis intensity threshold to an intensity above the press-input intensity threshold, a decrease in intensity of the contact below the press-input intensity threshold, and/or a decrease in intensity of the contact below the hysteresis intensity threshold corresponding to the press-input intensity threshold. Additionally, in examples where an operation is described as being performed in response to detecting a decrease in intensity of a contact below the press-input intensity threshold, the operation is, optionally, performed in response to detecting a decrease in intensity of the contact below a hysteresis intensity threshold corresponding to, and lower than, the press-input intensity threshold.

FIG. 5I illustrates exemplary electronic device 580. Device 580 includes body 580A. In some embodiments, device 580 can include some or all of the features described with respect to devices 100, 300, and 500 (e.g., FIGS. 1A-5B). In some embodiments, device 580 has one or more speakers 580B (concealed in body 580A), one or more microphones 580C, one or more touch-sensitive surfaces 580D, and one or more displays 580E. Alternatively, or in addition to a display and touch-sensitive surface 580D, the device has a touch-sensitive display (also referred to as a touchscreen). As with devices 100, 300, and 500, in some embodiments, touch-sensitive surface 580D (or the touch screen) optionally includes one or more intensity sensors for detecting intensity of contacts (e.g., touches) being applied. The one or more intensity sensors of touch-sensitive surface 580D (or the touchscreen) can provide output data that represents the intensity of touches. The user interface of device 580 can respond to touches based on their intensity, meaning that touches of different intensities can invoke different user interface operations on device 580. In some embodiments, the one or more displays 580E are one or more light-emitting diodes (LEDs). For example, a display can be a single LED, an LED cluster (e.g., a red, a green, and a blue LED), a plurality of discrete LEDs, a plurality of discrete LED clusters, or other arrangement of one or more LEDs. For example, the display 580E can be an array of nine discrete LED clusters arranged in a circular shape (e.g., a ring). In some examples, the one or more displays are comprised of one or more of another type of light-emitting elements.

FIG. 5J depicts exemplary personal electronic device 580. In some embodiments, device 580 can include some or all of the components described with respect to FIGS. 1A, 1B, 3, and 5A-5B. Device 580 has bus 592 that operatively couples I/O section 594 with one or more computer processors 596 and memory 598. I/O section 594 can be connected to display 582, which can have touch-sensitive component 584 and, optionally, intensity sensor 585 (e.g., contact intensity sensor). In some embodiments, touch-sensitive component 584 is a separate component than display 582. In addition, I/O section 594 can be connected with communication unit 590 for receiving application and operating system data, using Wi-Fi, Bluetooth, near field communication (NFC), cellular, and/or other wireless communication techniques. Device 580 can include input mechanisms 588. Input mechanism 588 is, optionally, a button, in some examples. Input mechanism 588 is, optionally, a microphone, in some examples. Input mechanism 588 is, optionally, a plurality of microphones (e.g., a microphone array).

Electronic device 580 includes speaker 586 for outputting audio. Device 580 can include audio circuitry (e.g., in I/O section 594) that receives audio data, converts the audio data to an electrical signal, and transmits the electrical signal to speaker 586. Speaker 586 converts the electrical signal to human-audible sound waves. The audio circuitry (e.g., in I/O section 594) also receives electrical signals converted by a microphone (e.g., input mechanism 588) from sound waves. The audio circuitry (e.g., in I/O section 594) converts the electrical signal to audio data. Audio data is, optionally, retrieved from and/or transmitted to memory 598 and/or RF circuitry (e.g., in communication unit 590) by I/O section 594.

Memory 598 of personal electronic device 580 can include one or more non-transitory computer-readable storage mediums, for storing computer-executable instructions, which, when executed by one or more computer processors 596, for example, can cause the computer processors to perform the techniques described below, including processes 700 and 800 (FIGS. 7 and 8)). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 580 is not limited to the components and configuration of FIG. 5J, but can include other or additional components in multiple configurations.

As used herein, an “installed application” refers to a software application that has been downloaded onto an electronic device (e.g., devices 100, 300, and/or 500) and is ready to be launched (e.g., become opened) on the device. In some embodiments, a downloaded application becomes an installed application by way of an installation program that extracts program portions from a downloaded package and integrates the extracted portions with the operating system of the computer system.

As used herein, the terms “open application” or “executing application” refer to a software application with retained state information (e.g., as part of device/global internal state 157 and/or application internal state 192). An open or executing application is, optionally, any one of the following types of applications:
an active application, which is currently displayed on a display screen of the device that the application is being used on;
a background application (or background processes), which is not currently displayed, but one or more processes for the application are being processed by one or more processors; and
a suspended or hibernated application, which is not running, but has state information that is stored in memory (volatile and non-volatile, respectively) and that can be used to resume execution of the application.

As used herein, the term “closed application” refers to software applications without retained state information (e.g., state information for closed applications is not stored in a memory of the device). Accordingly, closing an application includes stopping and/or removing application processes for the application and removing state information for the application from the memory of the device. Generally, opening a second application while in a first application does not close the first application. When the second application is displayed and the first application ceases to be displayed, the first application becomes a background application.

Attention is now directed towards embodiments of user interfaces (“UI”) and associated processes that are implemented on an electronic device, such as portable multifunction device 100, device 300, or device 500.

FIGS. 6A-6X illustrate exemplary user interfaces for managing the playback of media using a computer system in accordance with some examples. The user interfaces in these figures are used to illustrate the processes described below, including the processes in FIGS. 7 and 8.

FIG. 6A illustrates computer system 600, computer system 680, and distance diagram 602. As illustrated in FIG. 6A, computer system 600 includes rotatable input mechanism 604. At FIG. 6A, computer system 600 is depicted as a smart watch and computer system 680 is depicted as a smart speaker. Although computer system 600 is depicted as a smart watch, it should be recognized that this is merely an example and techniques described herein can work with other types of computer systems, such as a smart phone, tablet, and/or a smart speaker. Further, although computer system 680 is depicted as a smart speaker, it should be recognized that this is merely an example and techniques described herein can work with other types of computer systems, such as a smart watch, a smart television, a smart thermostat, an integrated lighting control, a personal gaming system, a laptop, and/or a tablet. In some examples, computer system 600 includes one or more features of devices 100, 300, and/or 500 as described above. In some examples, computer system 680 includes one or more features of device 580.

Distance diagram 602 is a visual aid that represents the distance between computer system 600 and computer system 680. As illustrated in FIG. 6A, distance diagram 602 includes representation of computer system 600-1, representation of computer system 680-1, inner threshold 682, and outer threshold 684. The positioning of representation of computer system 600-1 and representation of computer system 680-1 within distance diagram 602 is representative of the real-world positioning of computer system 600 with respect to computer system 680. Inner threshold 682 corresponds to a first predetermined distance (e.g., 1-8 inches) from computer system 680. Outer threshold 684 corresponds to a second predetermined distance (e.g., 8-16 inches) from computer system 680. As explained in greater detail below, both computer system 600 and computer system 680 can perform various operations based on the distance between computer system 600 and computer system 680. At FIG. 6A, as indicated by the positioning of representation of computer system 600-1 within distance diagram 602, computer system 600 is positioned outside of outer threshold 684.

As illustrated in FIG. 6A, computer system 600 displays media user interface 606 which includes page back control 608, time indicator 610, settings control 612, output indicator 614, media indicator 616a, and media playback controls 618. At FIG. 6A, media user interface 606 corresponds to the playback of a first media item by computer system 600. Because media user interface 606 corresponds to the playback of the first media item, computer system 600 displays media indicator 616a, a graphical representation of the first media item (e.g., entitled “Jacob's Tale”). As illustrated in FIG. 6A, computer system 600 displays media indicator 616a at a center location of media user interface 606. Computer system 600 displays page back control 608, time indicator 610, settings control 612, and output indicator 614 above media indicator 616a. Computer system 600 displays media playback controls 618 below media indicator 616. Time indicator 610 indicates the current time. As illustrated in FIG. 6A, time indicator 610 indicates that the current time is 10:10. In some examples, media indicator 616a includes a visual representation, the artist's name, the media title, the album title, and/or the playback length of the first media item.

Media playback controls 618 include skip back control 618a, play/pause control 618b, playback progress indicator 618c, and skip forward control 618d. At FIG. 6A, because media user interface 606 corresponds to the playback of the first media item by computer system 600, media playback controls 618 are configured to control the playback of the first media item. Further, as illustrated in FIG. 6A, computer system 600 displays playback progress indicator 618c as a ring surrounding play/pause control 618b. Playback progress indicator 618c indicates the progress (e.g., to completion) of the playback of the first media item with respect to the full runtime of the first media item. Computer system 600 indicates the progress of the playback of the first media item by filling in an amount of playback progress indicator 618c with a color that contrasts with the background color of media user interface 606. In some examples, playback progress indicator 618c is not circular in shape (e.g., playback progress indicator 618c can be shaped as a straight line, a triangle, and/or a semi-circle). In some examples, playback progress indicator 618c is located in a different portion of media user interface 606 (e.g., above media indicator 616a, to the side of media indicator 616a, and/or overlaid on media indicator 616a).

As illustrated in FIG. 6A, computer system 600 displays output indicator 614 overlapping a portion of settings control 612 within media user interface 606. Output indicator 614 includes an icon to represent the respective computer system that is designated to output the respective media item that corresponds to media user interface 606. At. FIG. 6A, computer system 600 outputs the first media item via a pair of headphones. Accordingly, as illustrated in FIG. 6A, computer system 600 displays an image of the pair of headphones within output indicator 614. In some examples, computer system 600 displays settings control 612 within media user interface 606 based on a determination that computer system 680 or computer system 600 is playing back a respective media item.

At FIG. 6A, as indicated by the presence of music notes 620 next to computer system 600, computer system 600 plays back the first media item via the pair of headphones and, as indicated by the absence of music notes next to computer system 680, computer system 680 is not playing back a respective media item. At FIG. 6A, computer system 600 is moved to closer to computer system 680 (e.g., a user physically moves computer system 600 closer).

Various media transfer processes are described throughout the descriptions of the examples illustrated in FIGS. 6A-6X. In these examples, the various media transfer processes involve repositioning computer system 600 relative to computer system 680. However, it should be noted that in some examples, the various media transfer processes described below can be performed by moving computer system 680 closer to computer system 600 and/or moving both computer system 600 and computer system 680 such that the distance between computer system 600 and computer system 680 is decreased.

FIGS. 6B-6H illustrate a first media transfer process for transferring playback of a respective media item (e.g., the first media item represented by media indicator 616a) from computer system 600 to computer system 680.

At FIG. 6B, as indicated by the positioning of representation of computer system 600-1 in distance diagram 602, computer system 600 has moved closer to computer system 680 (than in FIG. 6A) and reaches and crosses (e.g., all of computer system 600 crosses or a portion of computer system 600 crosses) to be within outer threshold 684. Further, at FIG. 6B, as indicated by the presence of music notes 620 in close proximity to computer system 600, computer system 600 continues to play back the first media item. At FIG. 6B, a determination is made (e.g., by computer system 600 and/or computer system 680) that computer system 600 reaches and crosses to be within outer threshold 684 while computer system 600 is playing back the first media item. As illustrated in FIG. 6B, based on the determination being made that computer system 600 reaches and crosses to be within outer threshold 684 while computer system 600 plays back the first media item, computer system 600 ceases displaying media user interface 606 and displays instructional indicator user interface 622. In some examples, the determination that computer system 600 reaches and crosses to be within outer threshold 684 and/or inner threshold 682 is made based on a determination that a signal strength (e.g., of a wireless signal such as a Wi-Fi wireless signal, Bluetooth wireless signal, and/or ultra-wideband wireless signal) of one or more signals (e.g., control signals and/or data) that is exchanged (e.g., transmitted) between the computer system 600 and computer system 680 changes (e.g., increases in strength, representing a decrease in proximity). In some examples, the determination that computer system 600 reaches and crosses to be within outer threshold 684 and/or inner threshold 682 is made by computer system 680 or computer system 600.

Instructional indicator user interface 622 includes object indicator 622a, instructions indicator 622b, and instructional media indicator 622c. As illustrated in FIG. 6B, computer system 600 displays instructions indicator 622b in the center of instructional indicator user interface 622. Computer system 600 displays object indicator 622a above instructions indicator 622b and computer system 600 displays instructional media indicator 622c below instructions indicator 622b. As illustrated in FIG. 6B, instructions indicator 622b includes textual instructions to move computer system 600 closer to computer system 680 and includes the given name of computer system 680. Instruction indicator 622b includes an arrow symbol above the textual instructions pointing to object indicator 622a. Object indicator 622a includes a visual representation of computer system 680. Instructional media indicator 622c is a graphical representation of the first media item being played back by computer system 600 (e.g., media indicator 616a in this example). In some examples, instructional media indicator 622c includes one or more features as described above with respect to media indicator 616a, including a graphical representation, the artist's name, the media title, the album title, and/or the playback length of the first media item. In some examples, computer system 600 displays instructional indicator user interface 622 based on a determination that computer system 600 reaches and crosses to be within outer threshold 684. In some examples, based on a determination that computer system 600 is moved closer to computer system 680 while computer system 600 is positioned outside of outer threshold 684, computer system 600 displays instructional indicator user interface 622. In some examples, instructional indicator user interface 622 does not include animations. In some examples, computer system 600 animates the display of instructional indicator user interface 622 (e.g., shaking, bouncing, rotating, and/or pulsing). In some examples, computer system 600 continues to display instructional indicator user interface 622 in response to a determination that computer system 600 is moved outside of outer threshold 684. In some examples, computer system 600 ceases to display instructional indicator user interface 622 based on the determination being made that computer system 600 is moved outside of outer threshold 684. In some examples, computer system 600 outputs a haptic output when computer system 600 reaches and crosses to be within outer threshold 684 as a result of computer system 600 being moved closer to computer system 600. In some examples, computer system 600 increases the intensity of haptic outputs while computer system 600 is positioned between outer threshold 684 and inner threshold 682 and as computer system 600 moves closer to inner threshold 682. In some examples, computer system 600 ceases to output a haptic output based on a determination that computer system 600 reaches and crosses to be within inner threshold 682 as a result of computer system 600 being moved towards inner threshold 682. In some examples, computer system 600 changes the intensity of the haptic outputs based on the distance between computer system 600 and computer system 680 while computer system 600 is positioned between inner threshold 682 and outer threshold 684 (e.g., higher intensities for shorter distances). At FIG. 6B, computer system 600 is moved towards computer system 680.

At FIG. 6C, as indicated by the positioning of representation of computer system 600-1 within distance diagram 602, computer system 600 is positioned between outer threshold 684 and inner threshold 682. At FIG. 6C, a determination is made (e.g., by computer system 600, computer system 680 and/or an external computer system (e.g., a server)) that computer system 600 is positioned between outer threshold 684 and inner threshold 682. As illustrated in FIG. 6C, based on the determination being made that computer system 600 is positioned between outer threshold 684 and inner threshold 682, computer system 600 displays media user interface 606 and ceases to display instructional indicator user interface 622.

At FIG. 6C, as indicated by the presence of music notes 620 in close proximity to computer system 600, computer system 600 continues to play back the first media item. In some examples, computer system 600 ceases to display instructional indicator user interface 622 based on a determination that computer system 600 is not positioned at outer threshold 684 (e.g., computer system 600 is positioned outside of outer threshold 684 or computer system 600 is positioned within outer threshold 684). At FIG. 6C, computer system 600 is moved towards computer system 680.

FIGS. 6D-6F illustrate a first animation that computer system 600 displays based on a determination that computer system 600 reaches and crosses to be within inner threshold 682 (e.g., as a result of computer system 600 being moved towards computer system 680) while computer system 600 is playing back media and while computer system 680 is not playing back media. The first animation includes a depiction of a media item moving towards a representation of a respective computer system such that a user has an indication of which computer system will be responsible for the playback of the media item once the transfer process is completed. In some examples, computer system 600 displays the below described animation while computer system 600 is positioned outside of inner threshold 682 and/or outer threshold 684.

As illustrated in FIG. 6D, and as indicated by the positioning of representation of computer system 600-1 within distance diagram 602, computer system 600 reaches and crosses to be within inner threshold 682 as a result of computer system 600 being moved towards computer system 680. At FIG. 6D a determination is made (e.g., by computer system 600, computer system 680, and/or an external computer system (e.g., a server)) that computer system 600 reaches and crosses to be within inner threshold 682 while computer system 600 plays back (e.g., via the pair of headphones), the first media item and while computer system 680 does not play back a respective media item. As illustrated in FIG. 6D, based on the determination being made that computer system 600 reaches and crosses to be within inner threshold 682 while computer system 600 plays back the first media item and while computer system 680 does not play back a respective media item, computer system 600 displays a first animation (e.g., as shown in FIGS. 6D-6G).

At FIG. 6D, as part of displaying the first animation, computer system 600 displays media indicator 616a decreasing in size and moving towards the bottom left corner of media user interface 606 from its starting position (as shown in FIG. 6C). Also, as illustrated in FIG. 6D, as part of displaying the first animation, computer system 600 dims the representations of settings control 612, output indicator 614, page back control 608, and media playback controls 618. In some examples, computer system 600 displays settings control 612 and/or output indicator 614 as visibly pulsing during the first animation. In some examples, as part of displaying the first animation, computer system 600 displays settings control 612 and/or output indicator 614 as pulsing after computer system 600 moves media indicator 616a. In some examples, computer system 600 ceases to display media playback controls 618, settings control 612 and/or output indicator 614 as part of displaying the first animation. In some examples, as part of displaying the first animation, computer system 600 ceases to display settings control 612 and/or output indicator 614 after displaying media indicator 616a as moving to the bottom left corner of media user interface 606. In some examples, computer system 600 fades out settings control 612 and/or output indicator 614 throughout the first animation until they are no longer visible at the end of the first animation. In some examples, computer system 600 fades out settings control 612 and/or output indicator 614 until they are no longer visible at an intermediary point of the first animation; computer system 600 then fades in setting control 612 and/or output indicator 614 until they are visible at the end of the first animation with output indicator 614 displaying an icon representing computer system 680 (e.g., replacing the icon for the headphones).

At FIG. 6D, as indicated by the presence of music notes 620 in close proximity to computer system 600, computer system 600 continues to play back the first media item while computer system 600 displays the first animation. In some examples, while computer system 600 displays the first animation, computer system 600 progressively decreases the volume of the playback of the first media item until computer system 600 is no longer playing back the first media at the end of the first animation. In some examples, while computer system 600 is positioned between outer threshold 684 and inner threshold 682, computer system 600 progressively decreases the volume of the playback of the first media item by computer system 600 based on a distance between computer system 600 and computer system 680.

FIG. 6E illustrates a continuation (e.g., a second frame or a sequential frame) of the first animation. As illustrated in FIG. 6E, at some time (e.g., 0.01-5 seconds) after computer system 600 decreases the size of media indicator 616a (e.g., as shown at FIG. 6D) and moves media indicator 616a to the bottom left corner of media user interface 606, computer system 600 ceases displaying media user interface 606 and displays top-down view representation of external computer system 624. Representation of external computer system 624 is a visual representation of the respective computer system that computer system 600 is moved towards. Accordingly, at FIG. 6E, representation of external computer system 624 is a representation of computer system 680. In some examples, computer system 600 displays representation of external computer system 624 by animating representation of external computer system 624 moving to a central location of the display of computer system 600. In some examples, computer system 600 displays representation of external computer system 624 by fading in representation of external computer system 624 at a location at the center of the display of computer system 600. In some examples, computer system 600 displays representation of external computer system 624 by increasing the size of external computer system 624 from a first size to a predetermined size at a location at the center of the screen.

Further, as illustrated in FIG. 6E, computer system 600 displays media indicator 616a as partially overlapping representation of external computer system 624. Based on the determination being made that computer system 600 reaches and crosses to be within inner threshold 682 while computer system 600 is playing back the first media item and while computer system 680 is not playing back a respective media item, display of the first animation includes media indicator 616a, which, as discussed above, is a graphical representation of the first media item. At FIG. 6E, as indicated by the presence of music notes 620 in close proximity to computer system 600, computer system 600 continues to play back the first media item while computer system 600 progresses through the first animation.

FIG. 6F illustrates a continuation (e.g., a second frame or a sequential frame) of the first animation. As illustrated in FIG. 6F, at some time after computer system 600 displays representation of external computer system 624 from the top-down view (e.g., as shown in FIG. 6E), computer system 600 moves the display of media indicator 616a such that all of media indicator 616a is overlaid on top of representation of external computer system 624. Also, at FIG. 6F, at some time after computer system 600 displays the top-down view of representation of external computer system 624, computer system 600 rotates the display of representation of external computer system 624 such that computer system 600 displays an isometric view of representation of external computer system 624. At FIG. 6F, as indicated by the presence of music notes 620 in close proximity to computer system 600, computer system 600 continues to play back the first media item while computer system 600 progresses through the first animation.

FIG. 6G illustrates a last frame of the first animation. As illustrated in FIG. 6G, at some time after computer system 600 rotates the display of representation of external computer system 624 at FIG. 6F, computer system 600 moves the display of media indicator 616a towards the top right corner of representation of external computer system 624. Also, as illustrated in FIG. 6G, at some time after computer system 600 rotates representation of external computer system 624 at FIG. 6F, computer system 600 rotates representation of external computer system 624 further such that computer system 600 displays a front view of representation of external computer system 624. At FIG. 6G, as indicated by the presence of music notes 620 in close proximity to computer system 600, computer system 600 continues to play back the first media item while computer system 600 progresses through the first animation. In some examples, computer system 600 displays media indicator 616a over the lower right corner of representation of external computer system 624 in the last frame of the first animation.

At FIG. 6H, computer system 600 has completed the display of the first animation. As illustrated in FIG. 6H, computer system 600 displays media user interface 606, including page back control 608 and media playback control 618, at the conclusion of the first animation. At FIG. 6H, after computer system 600 has completed displaying the first animation, computer system 600 transfers the playback of the first media item that is represented by media indicator 616a to computer system 680. Accordingly, at FIG. 6H, as indicated by the absence of music notes 620 in close proximity to computer system 600, computer system 600 does not play back the first media item. Further, at FIG. 6H, as indicated the presence of music notes 620 in close proximity to computer system 680, computer system 680 plays back the first media item. That is, when computer system 600 reaches and crosses to be within inner threshold 682 (e.g., as a result of computer system 600 being moved closer to computer system 600) while computer system 600 plays back a media item and computer system 680 does not play back a respective media item, computer system 600 automatically transfers the playback of a media item from computer system 600 to computer system 680. In some examples, computer system 600 transfers the playback of the first media item to computer system 680 before computer system 600 displays the first animation. In some examples, computer system 600 transfers the playback of the first media item to computer system 680 while computer system 600 displays the first animation. In some examples, computer system 600 transfers the playback of the first media item to computer system 680 when computer system 600 reaches and crosses to be within inner threshold 682 as a result of computer system 600 being moved towards computer system 680. In some examples, after computer system 600 displays the first animation, computer system 600 continues to play back the first media item while computer system 680 also plays back the first media item. In some examples, the playback of the first media item is synchronized between computer system 600 and computer system 680.

At FIG. 6H, the display of media user interface 606 corresponds to the playback of the first media item. Accordingly, computer system 600 displays media indicator 616a within media user interface 606. Further, as illustrated in FIG. 6H, because computer system 680 is the designated computer system responsible for the output of the first media item, computer system 600 displays output indicator 614 with an icon representative of computer system 680.

At FIG. 6H, as illustrated by the fill amount of playback progress indicator 618c, computer system 600 displays playback progress indicator 618c as filled in with more fill in FIG. 6H than in FIG. 6C. In this example, the progress of the playback of the first media item is not interrupted due to the transfer of the playback of the first media item from computer system 600 to computer system 680. That is, computer system 680 initiates the playback of the first media item at the same point in the first media item where computer system 600 ceased the playback (e.g., and has slightly progressed due to the passage of time between FIG. 6C and FIG. 6H, so more fill is displayed in playback progress indicator 618c). In some examples, computer system 680 initiates the playback of the first media item from the beginning of the first media item when the playback of the first media item is transferred to computer system 680. In some examples, computer system 680 initiates the playback of the first media item while computer system 600 is positioned between inner threshold 682 and outer threshold 684. In some examples, while computer system 600 is between inner threshold 682 and outer threshold 684, computer system 680 increases the volume of the playback of first media item based on the distance between computer system 600 and computer system 680. In some examples, while computer system 600 is between inner threshold 682 and outer threshold 684, computer system 600 decreases the volume of the playback of first media item based on the distance between computer system 600 and computer system 680. In some examples, both computer system 600 and computer system 680 are simultaneously playing back the first media item (e.g., one is increasing in volume as the other is decreasing in volume, and vice versa). In some examples, while computer system 600 is between inner threshold 682 and outer threshold 684, computer system 680 modifies the volume of the playback of first media item based on the distance between computer system 600 and computer system 680 (e.g., computer system 600 increases the volume of the playback of the first media item as the distance between computer system 600 and computer system 680 increases and computer system 600 decreases the volume of the playback of the first media item as the distance between computer system 600 and computer system 680 decreases). In some examples, based on the determination being made that computer system 600 reaches and crosses to be within inner threshold 682 based on computer system 600 moving closer to computer system 680, computer system 600 transfers the playback of a respective media item from an external computer system (e.g., tablet, smart phone, television, and/or smart speaker) to computer system 680. For example, computer system 600 can be in communication with a paired smart phone and/or be acting as a remote control for controlling playback on the smart phone. For further example, computer system 600 can also serve as a proxy device between the smart phone and computer system 680, such that when computer system 600 satisfies distance thresholds, playback of the smart phone is affected (e.g., transferred to computer system 680). At FIG. 6H, computer system 600 is moved away from computer system 680. In some examples, computer system 600 transfers the playback of the first media item in response to computer system reaching inner threshold 682. In some examples, computer system 600 transfers the playback of the first media while computer system 600 displays the first animation or before computer system 600 displays the first animation.

At FIG. 6I, as indicated by representation of computer system 600-1 within distance diagram 602, computer system 600 is positioned outside of outer threshold 684. As illustrated in FIG. 6I, computer system 600 continues to display media user interface 606. That is, computer system 600 maintains the display of media user interface 606 when computer system 600 transitions from being at and/or within inner threshold 682 to outside of outer threshold 684. At FIG. 6I, as indicated by the presence of music notes 620 in close proximity to computer system 680, computer system 680 continues to play the first media item after computer system 600 transitions from being at and/or within inner threshold 682 to outside of outer threshold 684. In some examples, the display of media user interface 606 does not timeout (e.g., computer system 600 does not cease displaying media user interface 606 after a predetermined amount of time). At FIG. 6I, computer system 600 detects voice command 605i. Voice command 605i corresponds to a request for computer system 600 to initiate the playback of a second media item.

At illustrated in FIG. 6J, in response to detecting voice command 605i, computer system 600 initiates, via the pair of headphones, the play back of a second media item entitled “Highway Firecracker”. Music notes 670 represents the playback of the second media item by computer system 600. Accordingly, at FIG. 6J, music notes 670 are in close proximity to computer system 600. At FIG. 6J, as indicated by the presence of music notes 620 in close proximity to computer system 680, computer system 680 continues to play back the first media item. That is, at FIG. 6J, computer system 600 plays back the second media item while computer system 680 plays back the first media item.

At FIG. 6J, as part of initiating the playback of the second media item, computer system 600 updates the display media user interface 606 such that media user interface 606 corresponds to the playback of the second media item on computer system 600. In this example, as illustrated in FIG. 6J, computer system 600 displays media user interface 606 with media indicator 616b that is representative of the second media item being played back by computer system 600. Further, as illustrated in FIG. 6J, because computer system 600 outputs the second media item via the pair of headphones, computer system 600 displays output indicator 614 with an icon representing the pair of headphones. At FIG. 6J, computer system 600 is moved towards computer system 680. In some examples, in response to computer system 600 transferring the playback of a respective media item to computer system 680, computer system 600 begins to play back a separate media item while computer system 680 plays back the respective media item. In some examples, the initiation of the playback of a media item by computer system 600 does not impact (e.g., cease or interrupt) the playback of a media item by computer system 680. In some examples, after computer system 600 transfers the playback of a respective media item, computer system 600 initiates the playback of a separate media item such that computer system 600 and computer system 680 are simultaneously playing back respective media items.

FIGS. 6K-6M illustrate a second media transfer process. The second media transfer process illustrated in FIGS. 6K-6M illustrates the transfer of the playback of a respective media item (e.g., the second media item represented by media indicator 616b) from computer system 600 to computer system 680.

At FIG. 6K, as illustrated by the positioning of representation of computer system 600-1, computer system 600 reaches and crosses to be within inner threshold 682 as a result of computer system 600 being moved towards computer system 680. At FIG. 6K, as indicated by the presence of music notes 620 in close proximity to computer system 680, computer system 680 is playing back the first media item (e.g., “Jacob's Tale”) and, as indicated by the presence of music notes 670 in close proximity to computer system 600, computer system 600 is playing back the second media item (e.g., “Highway Firecracker”).

At FIG. 6K, a determination is made (e.g., by computer system 600 computer system 680, and/or by an external computer system (e.g., server)) that computer system 600 reaches and crosses to be within inner threshold 682 while both computer system 600 and computer system 680 play back a respective media item. As illustrated in FIG. 6K, based on the determination being made that computer system 600 reaches and crosses the inner threshold 682 while both computer system 600 and computer system 680 play back a respective media item, computer system 600 displays a second animation. The second animation shows a depiction of a respective computer system, whose playback operations the user has expressed an interest in controlling (e.g., via the user moving computer system 600 towards the respective computer system), animating into the display of computer system 600 with an indication of the playback status of the computer system. In some examples, computer system 600 displays a first animation (e.g., as discussed above in FIGS. 6D-6G) when computer system 600 reaches and crosses to be within inner threshold 682 as a result of computer system 600 being moved towards computer system 680 while computer system 600 plays back a respective music item and while computer system 680 does not play back a respective media item. In some examples, computer system 600 displays a second animation when computer system 600 reaches and crosses to be within inner threshold 682 as a result of computer system 600 being moved towards computer system 680 while computer system 600 and computer system 680 play back a respective music item.

As illustrated in FIG. 6K, as part of displaying the second animation, computer system 600 displays media indicator 616a as partially overlapping representation of external computer system 624. That is, as part of displaying the second animation, computer system 600 displays a representation of the media item that computer system 680 is playing back as overlaid on top of representation of external computer system 624. Further, as illustrated in FIG. 6K, as part of displaying the second animation, computer system 600 dims the display of settings control 612 and output indicator 614 and displays output indicator 614 beneath settings control 612. As illustrated in FIG. 6K, output indicator 614 includes a graphical representation of the pair of headphones that computer system 600 outputs the second media item via. That is, though the second animation includes representation of external computer system 624, computer system 600 continues to display output indicator 614 with the indication of the computer system designated to output the second media item. In some examples, computer system 600 does not display output indicator 614 and settings control 612 during the second animation. In some examples, computer system 600 displays a graphical representation of computer system 680 within output indicator 614 while computer system 600 displays the second animation.

At FIG. 6L, computer system 600 has completed displaying the second animation. At FIG. 6L, as indicated by the presence of music notes 620 in close proximity to computer system 680, computer system 680 continues playing back the first media item (e.g., “Jacob's Tale”) and, as indicated by the presence of music notes 670 in close proximity to computer system 600, computer system 600 continues playing back the second media item (e.g., “Highway Firecracker”). That is, when computer system 600 reaches and crosses to be within inner threshold 682 while both computer system 600 and computer system 680 are playing back a respective media item (e.g., as described above with respect to FIG. 6K), computer system 600 does not automatically transfer the playback of a media item from computer system 600 to computer system 680. For example, computer system 600 does not automatically transfer the playback of a media item from computer system 600 to computer system 680 when a certain set of conditions exist. Such conditions can indicate that the intention to transfer media is unclear (e.g., computer system 600 is brought in close proximity to computer system 680 for a short period of time (e.g., 0.01-0.5 seconds), when transferring media may interrupt other playback (e.g., if computer system 680 is playing back media and computer system 600 transferring over different media would interrupt such playback), and/or when configured to not transfer media based on one or more settings (e.g., computer system 600 receives a setting to not interrupt playback under certain conditions of a respective media item and/or of respective computer system)).

As illustrated in FIG. 6L, after displaying the second animation, computer system 600 displays media user interface 606 as corresponding to the playback of media on computer system 680. As illustrated in FIG. 6L, because media user interface 606 corresponds to the playback of computer system 680, computer system 600 displays output indicator 614 with a graphic representation of computer system 680. Further, as illustrated in FIG. 6L, because media user interface 606 corresponds to the playback of media on computer system 680, computer system 600 displays media indicator 616a that is representative of the first media item that computer system 680 is playing back. Media user interface 606 corresponds to the playback of computer system 680 when media user interface 606 is displayed in response to computer system 600 reaching and crossing to be within inner threshold 682 (e.g., as a result of computer system 600 being moved towards computer system 680) while computer system 680 is actively playing back a media item. To the contrary, media user interface 606 corresponds to the playback of computer system 600 when media user interface 606 is displayed in response to computer system 600 reaching and crossing to be within inner threshold 682 (e.g., as a result of computer system 600 being moved towards computer system 680) while computer system 600 is actively playing back a media item and computer system 680 is not.

As illustrated in FIG. 6L, computer system 600 displays transfer control 626 within media user interface 606. Transfer control 626 includes transfer media indicator 626a, and transfer cancel control 626b. As discussed in greater detail below, selection of transfer control 626 corresponds to a request to transfer media from computer system 600 to computer system 680. When a determination is made (e.g., by computer system 600, computer system 680 and/or and external computer system (e.g., a server)) that computer system 600 reaches and crosses to be within inner threshold 682 while both computer system 680 and computer system 600 are playing back a respective media item, computer system 600 displays transfer control 626 within media user interface 606 after displaying the second animation.

At FIG. 6L, transfer media indicator 626a is a graphical representation of the second media item that computer system 600 is playing back. In some examples, computer system 600 continues to display transfer control 626 when computer system 600 is moved outside of outer threshold 684. In some examples, without detecting a respective input, computer system 600 ceases to display transfer control 626 when computer system 600 is moved outside of outer threshold 684. In some examples, computer system 600 ceases to display transfer control 626 in response to computer system 600 detecting an input directed to transfer cancel control 626b. At FIG. 6L, computer system 600 detects tap input 6051 directed to transfer control 626 (e.g., at a location of transfer control 626 that does not include transfer cancel control 626b). Further, at FIG. 6L, computer system 600 is moved away from computer system 680.

At FIG. 6M, as indicated by the positioning of representation of computer system 600-1 with distance diagram 602, computer system 600 is positioned outside of outer threshold 684. At FIG. 6M, in response to detecting tap input 6051, computer system 600 transfers the playback of the second media item (e.g., “Highway Firecracker”) from computer system 600 to computer system 680. Accordingly, at FIG. 6M, as indicated by the presence of music note 670 in close proximity to computer system 680, computer system 680 is playing back the second media item. At FIG. 6M, as part of transferring the playback of the second media item, computer system 600 causes computer system 680 to cease the playback of the first media item (e.g., “Jacob's Tale”) that computer system 680 was previously playing at FIG. 6L. Additionally, at FIG. 6M, as indicated by the lack of music notes 670 in close proximity to computer system 600, in response to detecting tap input 605L, computer system 600 ceases playing back the second media item. In some examples, computer system 600 ceases the playback of the second media item as part of transferring the playback of the second media item to computer system 680. In some examples, computer system 600 continues playback of the second media item as part of transferring the playback of the second media item to computer system 680.

Also, as illustrated in FIG. 6M, in response to detecting tap input 6051, computer system 600 updates the display of media user interface 606 such that media user interface 606 corresponds to the playback of the second media item on computer system 680. Accordingly, computer system 600 displays media user interface 606 with media indicator 616b that is a graphical representation of the second media item. At FIG. 6M, as indicated by the amount of playback progress indicator 618c that is filled in (e.g., in comparison to the amount of playback percentage indication that is filled in at FIG. 6J), the playback of the second media item is uninterrupted (e.g., does not restart) as a result of the transfer of the playback of the second media item from computer system 600 to computer system 680. At FIG. 6N, computer system 600 is moved towards computer system 680.

At FIG. 6N, as indicated by the positioning of representation of computer system 600-1 with distance diagram 602, computer system 600 reaches and crosses to be within inner threshold as a result of computer system 600 being moved towards computer system 680. At FIG. 6N, a determination is made (e.g., by computer system 600, computer system 680, and/or an external computer system (e.g., a server)) that computer system 600 reaches and crosses inner threshold 682 while computer system 680 plays back the second media item and while computer system 600 does not play back a respective media item. As illustrated in FIG. 6N, based on the determination being made that computer system 600 reaches and crosses inner threshold 682 while computer system 680 plays back the second media item and while computer system 600 does not play back a respective media item, computer system 600 displays a third animation. The third animation depicts the playback status of a respective computer system, whose playback operations the user has expressed an interest in controlling (e.g., via the user moving computer system 600 towards the respective computer system), as animating into the display of computer system 600.

As illustrated in FIG. 6N, as part of displaying the third animation, computer system 600 displays media indicator 616b over a portion of representation of external computer system 624. Because computer system 680 is playing back the second media item (e.g., that is represented by media indicator 616b) when computer system 600 reaches and crosses inner threshold 682, computer system 600 displays media indicator 616b over representation of external computer system 624 to indicate to a user the current playback state of computer system 680. As illustrated in FIG. 6N, computer system 600 displays settings control 612 and output indicator 614 as greyed out as part of displaying the third animation. In some examples, computer system 600 displays representation of external computer system 624 as rotating as a part of displaying the third animation.

At FIG. 6O, computer system 600 completes the display of the third animation. As illustrated in FIG. 6O, computer system 600 displays media user interface 606 after computer system 600 finishes displaying the third animation. At FIG. 6O, media user interface 606 corresponds to the playback of the second media item on computer system 680. Accordingly, as illustrated in FIG. 6O, computer system 600 displays media indicator 616b, that is representative of the second media item, within media user interface 606 and computer system 600 displays output indicator 614 with a graphical representation of computer system 680.

Additionally, as illustrated in FIG. 6O, computer system 600 displays transfer control 660 within media user interface 606. As discussed in greater detail below, selection of transfer control 660 corresponds to a request to transfer the playback of media from computer system 680 to computer system 600. That is, when a determination is made (e.g., by computer system 600, computer system 680, and/or an external computer system (e.g., a server)) that computer system 600 reaches and crosses to be within inner threshold 682 while computer system 680 is playing back a respective media item and computer system 600 is not playing back a respective media item, computer system 600 displays transfer control 660 (e.g., and not transfer control 626 as discussed above in FIG. 6L) within media user interface 606. At FIG. 6O, computer system 600 detects tap input 605o directed to transfer control 660. In some examples, computer system 600 continues to display transfer control 660 after computer system 600 is moved outside of inner threshold 682 and/or outer threshold 684.

At FIG. 6P, in response to detecting tap input 605o, computer system 600 causes computer system 680 to transfer the playback of the second media item from computer system 680 to computer system 600. Further, as part of causing computer system 680 to transfer the playback of the second media item, computer system 600 causes computer system 680 to cease the playback of the second media item. Accordingly, at FIG. 6P, as indicated by the presence of music notes 670 in close proximity to computer system 600, computer system 600 plays back, via the pair of headphones, the second media item and as indicated by the lack of music notes 670 in close proximity to computer system 680, computer system 680 does not playback the second media item.

At FIG. 6P, media user interface 606 corresponds to the playback of the second media item on computer system 600. Accordingly, as illustrated in FIG. 6P, computer system 600 continues displaying media indicator 616b (e.g., the graphical representation of the second media item) within media user interface 606. Also, as illustrated in FIG. 6P, because computer system plays back the second media item via the pair of headphones, computer system 600 displays output indicator 614 with graphical representation of the pair of headphones to indicate that the pair of headphones is responsible for outputting the second media item.

At FIG. 6P, as represented by the amount of playback progress indicator 618c that computer system 600 displays as filled in (e.g., in comparison to the amount of playback progress indicator 618c that is filed in at FIG. 6M), the playback of the second media item is not interrupted as a result of the transfer of the playback of the second media item from computer system 680 to computer system 600. At FIG. 6P, computer system 600 detects voice command 650p (e.g., uttered by a user nearby). Voice command 650p corresponds to a request for computer system 600 to cease the playback of the second media item.

At FIG. 6Q, as indicated by the lack of music notes 670 in close proximity to computer system 600, in response to detecting voice command 605p, computer system 600 ceases playing back the second media item. Accordingly, at FIG. 6Q, neither computer system 600 nor computer system 680 are playing back a respective media item. At FIG. 6Q, computer system 600 detects tap input 605q directed to rotatable input mechanism 604. Further, at FIG. 6Q, computer system 600 is moved away from computer system 680.

As illustrated in FIG. 6R, in response to detecting tap input 605q, computer system 600 displays application selection user interface 628. At FIG. 6R, as indicated by the positioning of representation of computer system 600-1 within distance diagram 602, computer system 600 is located outside of outer threshold 684. At FIG. 6R, computer system 600 is moved towards computer system 680.

At FIG. 6S, as indicated by the positioning of representation of computer system 600-1 within distance diagram 602, computer system 600 reaches and crosses to be within inner threshold 682 as a result of computer system 600 being moved towards computer system 680. At FIG. 6S, a determination is made (e.g., by computer system 600 computer system 680, and/or an external computer system (e.g., a server)) that computer system 600 reaches and crosses to be within inner threshold 682 while neither computer system 680 nor computer system 600 play back a respective media item. As illustrated in FIG. 6S, based on the determination being made that computer system 600 reaches and crosses to be within inner threshold 682 while neither computer system 680 nor computer system 600 play back a respective media item, computer system 600 displays a fourth animation. The fourth animation depicts a respective computer system, whose playback operations the user has expressed an interest in controlling (e.g., via the user moving computer system 600 towards the respective computer system), as animating into the display of computer system 600.

As illustrated in FIG. 6S, as a part of displaying the fourth animation, computer system 600 displays representation of external computer system 624. Computer system 600 displays representation of external computer system 624 as an indication of which computer system will be responsible for future playback operations and/or as an indication of which respective computer system computer system 600 is being placed near. At FIG. 6S, computer system 600 does not display settings control 612 nor output indicator 614 as part of displaying the fourth animation. At FIG. 6S, because computer system 600 and computer system 680 are not playing back respective media items, computer system 600 does not display a representation of a respective media item as part of displaying the fourth animation. Further, at FIG. 6S, as indicated by the absence of music notes in close proximity to computer system 600 and computer system 680, neither computer system 600 nor computer system 680 play back a respective media while computer system 600 displays the fourth animation. In some examples, computer system 600 rotates the display of representation of external computer system 624 during the fourth animation. In some examples, computer system 600 displays a representation of a media item that was recently played back by computer system 600 and/or computer system 680 as part of displaying the fourth animation. In some examples, for identification purposes, computer system 600 displays representation of external computer system 624 with visual characteristics that match the visual characteristics of computer system 680.

At FIG. 6T, computer system 600 completes the display of the fourth animation. As illustrated in FIG. 6T, computer system 600 displays recent media user interface 630 after computer system 600 displays the fourth animation. Recent media user interface 630 includes a selection of media items recently played by computer system 600, computer system 680, and/or external computer systems that are in communication with computer system 600 and/or computer system 680.

As illustrated in FIG. 6T, recent media user interface 630 includes page back control 608, time indicator 610, output indicator 614, first recent media item 632, second recent media item 634, third recent media item 636, and fourth recent media item 638. Each of recent media items 632-638 include a visual representation of a media item that was recently played back (e.g., by computer system 600, computer system 680, and/or an external computer system that is in communication with computer system 600 and/or computer system 680) and a graphical representation that represents a streaming service or device where the media item was sourced from. In some examples, each of the media items that are represented by recent media items 632-638 are sourced from either computer system 600, computer system 680, and/or external computer systems (e.g., not computer system 600 or computer system 680) that are registered with a common user account as computer system 600 and/or computer system 680. In some examples, each of the media items that are represented by recent media items 632-638 are sourced from a common streaming service.

At FIG. 6T, each of first recent media item 632, second recent media item 634, third recent media item 636, and fourth recent media item 638 are sourced from different sources (e.g., streaming services and/or devices). Recent media user interface 630 allows a user to access and play back media from a variety of different media sources that the user has recently expressed an interest in playing back. Further, recent media user interface 630 provides the user with an assortment of media items from various media sources that the user has recently expressed an interest in playing back. In some examples, computer system 600 displays more than four recently played media items as part of displaying recent media user interface 630. In some examples, computer system 600 displays less than four recently played media items as part of displaying recent media user interface 630. In some examples, computer system 600 displays recently played media items controls in a list format. In some examples, the selection of recently played media items are all from the same source. In some examples, computer system 600 organizes the selection of recently played media items in a chronological order (e.g., most recently played is displayed first or last). In some examples, computer system 600 organizes the selection of recently played media items based on a recency at which a respective source was accessed. In some examples, computer system 600 does not display recent media item 632-638 with a graphical representation of the source of the respective media item representing the streaming service or device the media was played on. In some examples, recent media items 632-638 include a graphical representation, the artist's name, the media title, the album title, and/or the playback length of the respective media item.

At FIG. 6T, as indicated by the absence of music notes in proximity to computer system 600 and computer system 680, neither computer system 600 nor computer system 680 are playing back a respective media item. Because neither of computer system 600 nor computer system 680 are playing back a respective media item, computer system 600 displays recent media user interface 630 without display settings control 612. At FIG. 6T, because computer system 600 displays recent media user interface 630 without settings control 612, computer system 600 displays the graphical representation of computer system 680 within output indicator 614 as a larger size in comparison to when computer system 600 displays output indicator 614 with settings control 612 (e.g., as shown in FIGS. 6L, 6M, and 6O).

At FIG. 6T, computer system 680 is designated as the computer system responsible for the playback of the media items represented by recent media items 632-638. As illustrated in FIG. 6T, because computer system 680 is designated as the computer system responsible for the playback of the media items represented by recent media items 632-638, computer system 600 displays output indicator 614 with a graphical representation of computer system 680. At FIG. 6T, computer system 600 detects tap input 605t directed to third recent media item 636.

At FIG. 6U, as indicated by the proximity of music notes 686 in close proximity to computer system 680, in response to detecting tap input 605t, computer system 600 causes computer system 680 to play back a third media item that corresponds to third recent media item 636, Further, as illustrated in FIG. 6U, in response to (and/or at some time after) detecting tap input 605t, computer system 600 displays media user interface 606. At FIG. 6U, media user interface 606 corresponds to the playback of the third media item. As illustrated in FIG. 6U, because media user interface 606 corresponds to the playback of the third media item, computer system 600 displays media indication 616c that is representative of the third media item within media user interface 606. Further, as illustrated in FIG. 6U, because computer system 680 is designated as the computer system responsible for the playback of the third media item, computer system 600 displays output indicator 614 with a graphical representation of computer system 680. At FIG. 6U, because computer system 600 displays output indicator 614 as overlaid on settings control 612, the graphical representation of computer system 680 included within output indicator 614 is smaller than the graphical representation of computer system 680 included within output indicator 614 at FIG. 6T. At FIG. 6U, computer system 600 detects tap input 605u directed to (e.g., representing selection of) settings control 612.

As illustrated in FIG. 6V, in response to detecting tap input 605u, computer system 600 displays audio output selection user interface 640. As illustrated in FIG. 6V, audio output selection user interface 640 includes exit control 642, time indicator 610, list type indicator 644a, first output control 646, second output control 648, and third output control 650. At FIG. 6V, as indicated by the proximity of music notes 686 in close proximity to computer system 680, computer system 680 continues to playback the third media item.

Each of first output control 646, second output control 648, and third output control 650 correspond to a respective computer system (e.g., a pair of headphones, an external speaker, a smartwatch, a smartphone, and/or a personal computer). As illustrated in FIG. 6V, each of first output control 646, second output control 648, and third output control 650 includes a graphical and textual representation of the respective computer system that corresponds to the respective control. Each respective computer system that corresponds to each of first output control 646, second output control 648, and third output control 650 are in communication (e.g., wireless communication and/or wired communication) with computer system 600 and/or computer system 680. In some examples, audio output selection user interface 640 is scrollable. In some examples, computer system 600 concurrently displays more than three selectable output controls within audio output selection user interface 640. In some examples, computer system 600 displays less than three selectable output controls within audio output selection user interface 640. In some examples, the computer systems that correspond to each of first output control 646, second output control 648, and third output control 650 are different types of computer systems. In some examples, the computer systems that correspond to each of first output control 646, second output control 648, and third output control 650 are registered with a common user account. In some examples, the computer systems that correspond to each of first output control 646, second output control 648, and third output control 650 are commonly owned. At FIG. 6V, computer system 600 detects tap input 605v directed to first output control 646.

At FIG. 6W, in response to detecting tap input 605v, computer system 600 causes computer system 680 to transfer the playback of the third media item from computer system 680 to computer system 600. Accordingly, at FIG. 6W, as indicated by the presence of music notes 686 in close proximity to computer system 600, computer system 600 plays back, via the pair of headphones, the third media item. As part of causing computer system 680 to transfer the playback of the third media item to computer system 600, computer system 600 causes computer system 680 to cease the playback of the third media item as part of transferring the third media item from computer system 680 to computer system 600, as indicated by the lack of music notes 686 in close proximity to computer system 680.

As illustrated in FIG. 6W, in response to detecting tap input 605v, computer system 600 displays media user interface 606 and ceases the display of audio output selection user interface 640. At FIG. 6W, media user interface 606 corresponds to the playback of the third media item by computer system 600. Accordingly, as illustrated in FIG. 6W, computer system 600 displays output indicator 614 with an icon representing the pair of headphones that computer system 600 plays back the third media item via. At FIG. 6W, as indicated by the amount that computer system 600 displays playback progress indicator 618c as filled in (e.g., in comparison to the amount that computer system 600 displays playback progress indicator 618c as filled in at FIG. 6U), the progress of the playback of the third media item is not interrupted as a result of the transfer of the playback from computer system 680 to computer system 600. At FIG. 6W, computer system 600 detects tap input 605w directed to page back control 608.

As illustrated in FIG. 6X, in response to detecting tap input 605w, computer system 600 displays device selection user interface 652. Device selection user interface 652 includes exit control 642, time indicator 610, list type indicator 644b, first device control 654, second device control 656, and third device control 658. Each of first device control 654, second device control 656, and third device control 658 corresponds to a respective computer system that is in communication with computer system 600 and/or computer system 680. Computer system 600 configures itself to control the media operations of a corresponding computer system in response to detecting an input corresponding to selection of one of first device control 654, second device control 656, or third device control 658. In some examples, in response to detecting an input that corresponds to one of first device control 654, second device control 656, or third device control 658, computer system 600 displays a media user interface (e.g., similar to media user interface 606) that corresponds to the playback of the respective computer system that corresponds to the selected control.

FIG. 7 is a flow diagram illustrating a method (e.g., method 700) for managing the playback of media in accordance with some examples. Some operations in method 700 are, optionally, combined, the orders of some operations are, optionally, changed, and some operations are, optionally, omitted.

As described below, method 700 provides an intuitive way for managing the playback of media. Method 700 reduces the cognitive burden on a user for managing the playback of media, thereby creating a more efficient human-machine interface. For battery-operated computing devices, enabling a user to manage the playback of media faster and more efficiently conserves power and increases the time between battery charges.

In some examples, method 700 is performed at a first computer system (e.g., 600) that is in communication with a display generation component (e.g., a display screen and/or a touch-sensitive display). In some examples, the first computer system is in communication with one or more input devices (e.g., a physical input mechanism (e.g., a hardware input mechanism, a rotatable input mechanism, a crown, a knob, a dial, a physical slider, and/or a hardware button)), a camera, a touch-sensitive display, a microphone, and/or a button. In some examples, the first computer system is a watch, a phone, a tablet, a processor, a head-mounted display (HMD) device, and/or a personal computing device.

At 702, in accordance with a determination that a first set of one or more criteria is satisfied while a second computer system (e.g., the first computer system or a different computer system) is outputting media (e.g., 620 and/or 670) (e.g., the second computer system outputs audio and/or video that corresponds to the media and/or the second computer system causes an external computer system (e.g., headphones and/or speaker) to output audio and/or video that corresponds to the media), wherein the first set of one or more criteria includes a criterion that is satisfied when the first computer system (e.g., 600) is determined to be within a predefined distance (e.g., 682) (e.g., a threshold distance) (e.g., 1-12 inches) from a third computer system (e.g., 680) (e.g., different from the second computer system, or the same as the second computer system) (a smart speaker, a television, a display, a smartwatch, a smartphone, a desktop computer, a tablet, and/or a radio) while the second computer system is outputting media (e.g., 620 and/or 670) (e.g., the second computer system outputs audio and/or video that corresponds to the media and/or the second computer system causes an external computer system (e.g., headphones and/or speaker) to output audio and/or video that corresponds to the media) (e.g., the first set of one or more criteria is satisfied when the distance between the first computer system and the third computer system is less than a threshold distance, a playback volume relationship between the first computer system and the third computer system satisfies a set of one or more criteria (e.g., the playback volume of the first computer system is twice as loud as the playback volume of the third computer system or the playback volume of the first computer system and the third computer system are the same), and/or the playback status of the first computer system and the third computer system are the same (e.g., the first computer system and the third computer system are playing back the same media item, both the first computer system and the third computer system are playing back a different respective media item, or neither the first computer system nor the third computer system are playing back a respective media) the first computer system causes 704, the third computer system (e.g., 680), to output the media (e.g., 620, and/or 670) (e.g., the second computer system ceases to output the media or the second computer system continues to output the media) (e.g., the output of the media by the second computer system and the third computer system are in sync or the second computer system ceases to output the media at a first point in the media and the third computer system begins to output the media at the first point in the media) and the first computer system changes (706) (e.g., via a looping animation or a one-time animation), via the display generation component, a display location of a first representation of the media (e.g., 616a and/or 616b) (e.g., a graphical representation and/or a textual representation of the media) from a first location (e.g., location of 616a at FIGS. 6C, 6D, and/or 6E) (e.g., in a respective user interface and/or in the display generation component) to a second location (e.g., location of 616a at FIG. 6F and/or FIG. 6G) (e.g., in the respective user interface and/or on the display generation component), wherein the second location corresponds to a display location of a representation (e.g., 624) (e.g., a graphical representation and/or a textual representation) of the third computer system (e.g., 680) (e.g., the third computer system and the first computer system are different types of computer systems or the third computer system and the first computer system are the same types of computer systems) and the first location does not correspond to a location of the display location of the first representation of the third computer system (e.g., 680) (e.g., the first computer system ceases to display a respective user interface as part of changing the display of the first representation of the media or the first computer system continues to display the respective user interface as part of changing the display of the respective user interface) (e.g., while the first representation of the media is at the first position, the first computer system ceases to display the first representation of the media and the first computer system redisplays the first representation of the media at the second position in the respective user interface or the first computer system maintains the display of the first representation of the media while the first representation of the media moves from the first position to the second position). In some examples, outputting media includes outputting one or more signals (e.g., waveform and/or an encoded or unencoded media stream) to one or more output devices (e.g., display and/or speaker in communication with the computer system) that cause the one or more output devices to generate a perceptible (e.g., audio and/or visual) output according to the media (e.g., play back the media). In some examples, outputting media includes outputting data (e.g., a media stream) representing media to another computer system (e.g., a companion device, a smart speaker, and/or headphones) that is configured to (e.g., is under the control of the computer system and/or plays back the media on command (e.g., without requiring additional user input) in response to receiving the data) generate a perceptible output according to the media.

At 708, in accordance with a determination that a second set of one or more criteria is satisfied (e.g., the second set of one or more criteria is different (e.g., the first set of criteria is satisfied and the second set of criteria is not satisfied or the second set of criteria is satisfied and the first set of criteria is not satisfied) and/or distinct from the first set of one or more criteria) (e.g., the distance between the first computer system and the third computer system is less than a threshold distance, a playback volume relationship between the first computer system and the third computer system satisfies a set of one or more criteria (e.g., the playback volume of the first computer system is twice as loud as the playback volume of the third computer system or the playback volume of the first computer system and the third computer system are the same), and/or the playback statuses of the first computer system and the third computer system are the same (e.g., the first computer system and the third computer system are playing back the same media item, both the first computer system and the third computer system are playing back a respective media item, or neither the first computer system nor the third computer system are playing back a respective media item)), wherein the second set of one or more criteria includes a criterion that is satisfied when the first computer system (e.g., 600) is determined to be within the predefined distance (e.g., 682) from the third computer system (e.g., 680) while the second computer system is outputting media (e.g., 620 and/or the first computer system) the first computer system forgoes (710) causing the third computer system (e.g., 680) to output respective media (e.g., 680 at FIGS. 6E and/or 6P) (e.g., the media or different media) (e.g., the second computer system ceases to output the media or the second computer system continues to output the media) and the first computer system forgoes (712) changing the display location of the first representation of the media from the first location (e.g., location of 616a at FIGS. 6C, 6D, and/or 6E) to the second location (e.g., location of 616a at FIGS. 6F and/or 6G). In some examples, the first computer system changes the size, color, and/or shape of the first representation of the media as a part of changing the display location of the first representation of the media. In some examples, the first computer system detects the distance between the first computer system and the third computer system based on a wireless signal strength (e.g., a Bluetooth signal, a Wi-Fi signal, and/or an Ultra-Wideband signal) between the first computer system and the third computer system. In some examples, changing the display location of the first representation of the media includes displaying a fading out animation, a fading in animation, and/or a rotation animation. In some examples, the first computer system animates a respective user interface that the first computer system displays the first representation of the media within as part of changing the display location of the first representation of the media item. In some examples, the first computer system displays a respective user interface prior to changing the display location of the first representation of the media and after changing the display location of the first representation of the media changing. In some examples, the first computer system displays different user interfaces before and after changing the display location of the first representation of the media. In some examples, the first computer system ceases to display a respective user interface for a period of time while the display location of the first representation of the media is changing. Causing the third computer system to output media and changing the display location of the media from a first location to a second location related to a third computer system when prescribed conditions are satisfied allows the first computer system to indicate to a user of the first computer system that media output is changing and a destination of the output and allows the first computer system to automatically control playback status of the first computer system and the third computer system without displaying additional controls, thereby providing additional control options without cluttering the user interface. Selectively causing the third computer system to output media when prescribed conditions are satisfied allows the first computer system to prevent automatically interrupting playback status of the third computer system at a point in time when a user is proximate to the third computer system without causing the third computer system to cease outputting something else, thereby performing an operation when a set of conditions has been met without requiring further user input.

In some examples, the first set of one or more criteria includes a criterion that is satisfied when the third computer system (e.g., 680) is determined to be not outputting media (e.g., 680 at FIGS. 6A, 6B, 6C, 6D, 6E and/or 6P) (e.g., is not presently outputting media, has not output media within a threshold time period (e.g., 1-60 seconds)). In some examples, the first set of one or more criteria is satisfied when the third computer system is determined to be not outputting media while the second computer system is outputting media. Changing the display location of the first representation of the media from a first location to a second location when it is determined that the third computer system is not outputting a respective first media item provides a user with visual feedback regarding the playback status of the third computer system, thereby providing improved visual feedback.

In some examples, the second set of one or more criteria includes a criterion that is satisfied when the third computer system (e.g., 680) is determined to be outputting media (e.g., 620 and/or 670) (e.g., 680 at FIGS. 6I, 6J, 6K and/or 6L) (e.g., and the second computer system is concurrently playing back a media item (e.g., the third computer system and the second computer system are playing back the same media item or different media items)). Forgoing causing the third computer system to output media and forgoing changing the display location of the first representation of the media from the first location to the second location when it is determined that the third computer system is playing back a second media item allows the first computer system to indicate to a user media playback status of the third computer system, reducing the need for display operations and related extraneous processes to be performed by the first computer system, thereby providing improved visual feedback to the user, conserving the battery life of the first computer system, and performing an operation when a set of conditions has been met without requiring further user input.

In some examples, in accordance with a determination that the first set of one or more criteria is satisfied while the second computer system is outputting media (e.g., 620 and/or 670), the first computer system causes the second computer system to cease the output of the media (e.g., as discussed above at FIG. 6H) (e.g., the second computer system ceases output of the media as part of and/or in addition to causing the third computer system to output the media) (e.g., the second computer system ceases to output the media before, concurrently with, or after causing the third computer system to output the media). In some examples, the second computer system ceases outputting the media at a first point of the media and the third computer system begins to output the media at the first point. In some examples, the third computer system outputs the media from the start of the media item. In some examples, the third computer system outputs different media than the media that the second computer system ceased outputting. Ceasing output of the media on the second computer system and causing the third computer system to output the media when the first set of criteria is satisfied allows the user to control the playback status of both the second computer system and the third computer system without displaying additional controls, thereby providing additional control options without cluttering the user interface.

In some examples, in accordance with a determination that a third set of one or more criteria is satisfied (e.g., the distance between the first computer system and the third computer system is less than a first predefined distance (e.g., threshold) and greater than a second predefined distance (e.g., threshold), the distance between the first computer system and the third computer system is greater than a predefined distance (e.g., threshold), the distance between the first computer system and the third computer system is less than a predetermined distance, and/or playback statuses of the second computer system and the third computer system are the same (e.g., the second computer system and the third computer system are playing back the same media item, both the second computer system and the third computer system are playing back a respective media item, or neither the second computer system nor the third computer system are playing back a respective media item)), wherein the third set of one or more criteria includes a criterion that is satisfied when the first computer system (e.g., 600) is determined to be within a second predefined distance (e.g., 684) (e.g., 24-48 inches) from the third computer system (e.g., 680) but not within the predefined distance (e.g., 682) from the third computer system (e.g., is within a threshold distance, but not as close as required by a smaller threshold), the first computer system displays, via the display generation component, a user interface (e.g., 622) indicating that the first computer system (e.g., 600) is not within the predefined distance (e.g., 682) from the third computer system (e.g., 680) (e.g., the user interface, indicating that the first computer system is not within the predefined distance from the third computer system, indicates one or more operations that the first computer system will perform if the distance between the first computer system and the third computer system increases and/or decreases or the user interface indicates one or more operations that the third computer system will perform if the distance between the first computer system and the third computer increases and/or decreases). In some examples, the second set of criteria and the third set of criteria are concurrently satisfied. In some examples, the first set of criteria and the third set of criteria are concurrently satisfied. In some examples, the first computer system ceases to display the user interface, indicating that the first computer system is not within the predefined distance from the third computer system, in accordance with a determination that the distance between the first computer system and the third computer system increases beyond a respective distance threshold or decreases within a respective distance threshold. In some examples, the first computer system displays the user interface, indicating that the first computer system is not within the predefined distance from the third computer system, without causing the third computer system to output the media and/or without changing the display location of the first representation of the media from the first location to the second location. Displaying the user interface in accordance with a determination that the third set of one or more criteria is satisfied allows the first computer system to indicate to a user a current state of the first computer system when the first set of one or more criteria is satisfied, thereby providing improved visual feedback to the user and/or performing an operation when a set of conditions has been met without requiring further user input.

In some examples, the first computer system (e.g., 600) is in communication (e.g., wired communication and/or wireless communication (e.g., Wi-Fi, Bluetooth, and/or ultra-wideband)) with a fourth computer system (e.g., as discussed above at FIG. 6H) (e.g., a smartwatch, tablet, smartphone, laptop, and/or personal desktop) (e.g., the third computer system and the fourth computer system are the same type of computer systems or are different types of computer systems (e.g., the third computer system is a smart speaker and the fourth computer system is a smart phone or the third computer system is a personal computer and the fourth computer system is a pair of headphones)) (e.g., the first computer system and the fourth computer system are the same type of computer systems or different types of computer systems (e.g., the first computer system is a smart speaker and the fourth computer system is a smart phone or the first computer system is a personal computer and the fourth computer system is a pair of headphones)) different from the first computer system. In some examples, in accordance with a determination that a fourth set of one or more criteria is satisfied while the fourth computer system outputs a second media item (e.g., media item represented by 616a and/or 616b) (e.g., a video media and/or an audio media), wherein the fourth set of one or more criteria includes a criterion that is satisfied when the first computer system is determined to be within the predefined distance (e.g., 684 and/or 682) (e.g., 1-24 inches) from the third computer system (e.g., 680): the first computer system causes (e.g., via the first computer system and/or the fourth computer system) the third computer system (e.g., 680) to initiate output of the second media item (e.g., media item represented by 616a and/or 616b) (e.g., causing the third computer system to output the second media item includes causing the third computer system to cease outputting a respective media or causing the third computer system to output the second media includes causing the third computer system to transition from not outputting a respective media to outputting the second media item). In some examples, the fourth set of one or more criteria is satisfied irrespective of a distance between the first computer system and the third computer system. In some examples, the determination that the fourth set of one or more criteria is satisfied is made while the fourth computer system is not outputting a respective media item. In some examples, in accordance with a determination that a fourth set of one or more criteria is satisfied while the fourth computer system outputs a second media item (e.g., a video media and/or an audio media), wherein the fourth set of one or more criteria includes a criterion that is satisfied when the first computer system is determined to be within the predefined distance (e.g., 1-24 inches) from the third computer system, the first computer system causes the fourth computer system to cease output of the second media item. In some examples, in accordance with a determination that the third set of one or more criteria is not satisfied, the first computer system foregoes causing the third computer system to output the second media item. In some examples, the fourth computer system continues to output the second media item while the third computer system outputs the second media item. In some examples, the first computer system causes the third computer system to initiate output of the second media before, after, and/or concurrently with causing the fourth computer system to cease output of the second media. In some examples, the fourth computer system ceases output of the second media item at a first point of the second media item and the third computer system initiates output of the second media item at the first point of the second media item. In some examples, the third computer system initiates output of the second media from the beginning of the second media. In some examples, the first computer system causes the third computer system to initiate output of the media irrespective of the distance of the fourth computer system from the first computer system and/or the second computer system. In some examples, the first computer system is not outputting a respective media item when and/or while the first computer system causes the third computer system to initiate output of the second media item. Causing the third computer system to initiate output of the second media item when a fourth set of one or more criteria is satisfied allows the user to control the playback status of the third computer system based on proximity of the third computer system without displaying additional controls, thereby providing additional control options without cluttering the user interface and performing an operation when a set of conditions has been met without requiring further user input.

In some examples, changing the display location of the first representation of the media (e.g., location of 616a and/or 616b) from the first location (e.g., location of 616a at FIGS. 6A, 6C, and/or 6D) to the second location (e.g., location of 616a at FIGS. 6E, 6F, and/or 6G) includes displaying the first representation of the media (e.g., 616a and/or 616b) as overlaid (e.g., the first representation of the media item is overlaid over a portion of the first representation of the third computer system or the entirety of the first representation of the third computer system) on the first representation of the third computer system (e.g., 624 at FIGS. 6E, 6F, and/or 6G). Displaying the representation of the media as overlaid on the first representation of the third computer system provides the user with visual feedback regarding what media item the third computer system is playing back and/or will play back and provides the user with visual feedback that the first set of one or more criteria is satisfied, thereby providing improved visual feedback.

In some examples, in accordance with a determination that the second set of one or more criteria is satisfied, the first computer system (e.g., 600) displays a second representation of the respective media (e.g., location of 616a and/or 616b at FIGS. 6K and/or 6N) (e.g., a textual representation or a graphical representation) (e.g., the second representation of media corresponds to media that is currently output by the second computer system or was recently output by the second computer system) (e.g., that is different from the first representation of the media or the same as the first representation of the media) as overlaid on a second representation of the third computer system (e.g., 624 at FIGS. 6K and/or 6N) (e.g., the second representation of media is overlaid over a portion of the representation of the third computer system or the entirety of the representation of the third computer system). Displaying a second representation of media as overlaid on the second representation of the third computer system provides the user with visual feedback regarding which media item the second computer system is currently playing back and/or configured to play back, thereby providing improved visual feedback.

In some examples, in accordance with a determination that the first set of one or more criteria is satisfied, after causing the third computer system (e.g., 680) to output the media (e.g., 620 and/or 670), the first computer system (e.g., 600) displays, via the display generation component, a first now playing user interface (e.g., 606 at FIGS. 6A, 6O, and/or 6L) (e.g., a user interface that corresponds to a media application that is installed on the first computer system and/or a user interface that corresponds to a media application that is accessible to the first computer system) that includes a third representation of the media (e.g., 616a, 616b, 660a, and/or 626b) (e.g., a media item that is played back on the third computer system, a media item that is played back by the first computer system and/or a media item that is played back on a respective computer system that the first computer system is configured to control) (e.g., the third representation of media and the first representation of media are the same or different). In some examples, in accordance with a determination that the second set of one or more criteria is satisfied, while the second computer system is outputting the media (e.g., 620 and/or 670), the first computer system displays, via the display generation component, the first now playing user interface that includes the third representation of the media (e.g., 616a, 616b, 660a, and/or 626b). In some examples, the first now playing user interface includes a first set of playback controls that, when selected, modify the playback status of the first computer system, the second computer system, and/or the third computer system. In some examples, the third representation of the media is displayed at a respective location that is different and/or distinct from the second location. In some examples, the first computer system displays the first now playing user interface with the third representation of the media without causing the second computer system and/or the third computer system to output media. Displaying the first now playing user after causing the third computer system to output media provides the user with feedback regarding the state of the first computer system (e.g., the first computer system has already changed the display location of the first representation of the media from the first location to the second location) and/or the state of the third computer system (e.g., the third computer system is outputting media), thereby providing improved visual feedback.

In some examples, after changing the display location of the first representation of the media (e.g., 616a and/or 616b) from the first location (e.g., location of 616a at FIGS. 6A, 6D, and/or 6E) to the second location (e.g., location of 616a at FIGS. 6D, 6E, 6F and/or 6G) and in accordance with a determination that the first set of one or more criteria is satisfied, the third representation of the media (e.g., 616a, 616b, 660a, and/or 626b) is displayed at a first position (e.g., location of 616b at FIG. 6M and/or location of 616a at FIG. 6L) of (e.g., in, with respect to, and/or on) the first now playing user interface (e.g., 606) (e.g., a central position of the first now playing user interface, a position at the top of the first now playing user interface, a position at the bottom of the first now playing user interface, a position on the right of the first now playing user interface, and/or a position on the left of the first now playing user interface). In some examples, in accordance with a determination that the second set of one or more criteria is satisfied, the third representation the media (e.g., 626a, 660a, 616a and/or 616b) is displayed at a second position (e.g., location of 660a at FIG. 6O, 626a at FIG. 6L) (e.g., the second position is different and/or distinct from the first position) of (e.g., in, with respect to, and/or on) the first now playing user interface (e.g., 606) (e.g., a central position of the first now playing user interface, a position at the top of the now playing user interface, a position at the bottom of the first now playing user interface, a position on the right of the first now playing user interface and/or a position on the left of the first now playing user interface) (e.g., after forgoing changing the display location of the first representation of the media from the first location to the second location). In some examples, the first position of the first now playing user interface overlaps with the second position of the first now playing user interface. In some examples, the first position of the first now playing user interface does not overlap with the second position of the first now playing user interface. Displaying the first representation of the media at a respective position of the first now playing user interface when a set of prescribed conditions are satisfied allows the first computer system to automatically perform a display operation that indicates whether the first set of criteria or the second set of criteria is satisfied, thereby performing an operation when a set of conditions has been met without requiring further user input.

In some examples, in accordance with a determination that the second set of one or more criteria is satisfied and after forgoing changing the display location of the first representation of the media from the first location to the second location, displaying the first now playing user interface (e.g., 606) includes displaying a first transfer user interface object (e.g., 626 and/or 660) (e.g., the first transfer user interface object is displayed within the first now playing user interface or outside of the first now playing user interface), that, when selected, causes the first computer system (e.g., 600) to transmit instructions to the third computer system (e.g., 680) that causes the transfer of the playback of the respective media (e.g., media represented by 616a, 616b, 620 and/or 670) (e.g., from the first computer system to the third computer system, from a respective external computer system to the third computer system, from the third computer system to the first computer system and/or from the third computer system to the respective external computer system). In some examples, the second computer system ceases to play back the respective media item in response to detecting selection of the first transfer user interface object. In some examples, the second computer system is playing back a respective media item when the first computer system detects an input that corresponds to selection of the first transfer user interface object and the second computer system continues to play back the respective media item in response to detecting the input. Displaying the first now playing user interface with a first transfer user interface when the second set of one or more criteria is satisfied provides that user with visual feedback that the second set of one or more criteria is satisfied, thereby providing improved visual feedback.

In some examples, in accordance with a determination that the first set of one or more criteria is satisfied, the first now playing user interface (e.g., 606) does not include the first transfer user interface object (e.g., 660 and/or 626) (e.g., 606 at FIGS. 6A, 6H, 6I, 6J, and/or 6M). Displaying the first now playing user interface without displaying the first transfer user interface object reduces the number of display operations that are performed by the first computer system and reduces the number of processes that are performed by the first computer system, thereby conserving the battery life of the first computer system.

In some examples, the first now playing user interface (e.g., 606) continues to be displayed without respect to (e.g., irrespective of) a distance between the first computer system (e.g., 600) and the third computer system (e.g., 680). In some examples, the first computer system displays the first now playing user interface while the distance between the first computer system and the third computer system is less than, equal to, and/or greater than the predefined distance (e.g., after the first computer system moves away from the third computer system). Displaying the first now playing user interface with respect to the distance between the first computer system and the third computer system allows the user to move without restriction while maintaining the ability to view the first now playing user interface, thereby providing improved visual feedback.

In some examples, in accordance with a determination that a third set of one or more criteria is satisfied, wherein the third set of one or more criteria includes a criterion that is satisfied when the first computer system (e.g., 600) is determined to be within the predefined distance (e.g., 682) from the third computer system (e.g., 680) while the third computer system (e.g., 680) is outputting media (e.g., 620 and/or 670) (e.g., 680 at FIGS. 6H, 6I, 6J and/or 6K) (e.g., and the first set of one or more criteria is not satisfied and/or the second set of one or more criteria is not satisfied) (e.g., the distance between the first computer system and the third computer system is less than a threshold distance, a playback volume relationship between the first computer system and the third computer system satisfies a set of one or more criteria (e.g., the playback volume of the first computer system is twice as loud as the playback volume of the third computer system or the playback volume of the first computer system and the third computer system are the same), playback statuses of the first computer system and the third computer system are the same (e.g., the first computer system and the third computer system are playing back the same media item, both the first computer system and the third computer system are playing back a respective media item, or neither the first computer system nor the third computer system are playing back a respective media item), the third computer system is playing back a media item and the first computer system is not playing back a media item, and/or both the third computer system and the first computer system are playing back a respective media item), the first computer system displays, via the display generation component, a second transfer user interface object (e.g., 626 and/or 660). In some examples, displaying the second transfer user interface object includes displaying, via the display generation component, a second now playing user interface that includes the second transfer user interface object (e.g., a user interface that corresponds to a media application that is installed on the first computer system and/or a user interface that corresponds to a media application that is accessible to the first computer system) (e.g., the second now playing user interface includes a representation of respective media that is output (e.g., currently output and/or previously output) by the third computer system that is different (e.g., and/or distinct) from the first representation of media). In some examples, when the first computer system detects an input that corresponds to selection of the second transfer user interface object, the first computer system transmits instructions to the third computer system that cause the third computer system to transfer playback of the respective media item to the first computer system and/or second computer system. In some examples, the second transfer user interface object, when selected (e.g., via input), causes the first computer system to output the respective media (e.g., transfer playback of the respective media being output by the third computer system to be output by the first computer system). Displaying a second transfer user interface object when the third set of one or more criteria is satisfied allows the user to control when the second now playing user interface is displayed without requiring that the first computer system display additional controls, thereby providing additional control options without cluttering the user interface.

In some examples, in accordance with a determination that a third set of one or more criteria is satisfied, the first computer system displays a third representation (e.g., 614 and/or 624) (e.g., a textual representation and/or graphical representation) of the third computer system (e.g., 680) (e.g., the third representation is displayed as overlaid on a respective user interface object) concurrently with the second transfer user interface object (e.g., 626 and/or 660). In some examples, displaying the third representation of the third computer system includes displaying an animation (e.g., an animation that is different and/or distinct from the first and/or second animation) (e.g., a fading out animation, a fading in animation, an animation of a representation of the third computer system, and/or an animation of a representation of the first computer system). In some examples, displaying the animation includes displaying a representation of a media item that is played back by the third computer system. Displaying a third representation of the third computer system provides a user with visual feedback that the third set of one or more criteria is satisfied, thereby providing improved visual feedback.

Note that details of the processes described above with respect to method 700 (e.g., FIG. 7) are also applicable in an analogous manner to other methods described herein. For example, method 800 optionally includes one or more of the characteristics of the various methods described above with reference to method 700. For example, the transfer user interface object can be used to transfer a recently played media item from a first respective computer system to a second respective computer system. For brevity, these details are not repeated below.

FIG. 8 is a flow diagram illustrating a method (e.g., method 800) for managing the playback of recently played media items in accordance with some examples. Some operations in method 800 are, optionally, combined, the orders of some operations are, optionally, changed, and some operations are, optionally, omitted.

As described below, method 800 provides an intuitive way for managing the playback of recently played media items. Method 800 reduces the cognitive burden on a user for managing the playback of recently played media items, thereby creating a more efficient human-machine interface. For battery-operated computing devices, enabling a user to manage the playback of recently played media items faster and more efficiently conserves power and increases the time between battery charges.

In some examples, method 800 is performed at a computer system (e.g., 600) that is in communication with a display generation component (e.g., a display screen and/or a touch-sensitive display) and one or more input devices (e.g., 604) (e.g., a physical input mechanism (e.g., a hardware input mechanism, a rotatable input mechanism, a crown, a knob, a dial, a physical slider, and/or a hardware button), a camera, a touch-sensitive display, a microphone, and/or a button). In some examples, the computer system is a watch, a phone, a tablet, a processor, a head-mounted display (HMD) device, and/or a personal computing device.

At 802, in accordance with a determination that a first set of one or more criteria is satisfied (e.g., the distance between the computer system and the external computer system is less than a threshold distance, a playback volume relationship between the computer system and the external computer system satisfies a set of one or more criteria (e.g., the playback volume of the computer system is twice as loud as the playback volume of the external computer system or the playback volume of the computer system and the external computer system are the same), and/or the playback statuses of the computer system and the external computer system are the same (e.g., the computer system and the external computer system are playing back the same media item, both the computer system and the external computer system are playing back a respective media item, or neither the computer system nor the external computer system are playing back a respective media item)), wherein the first set of one or more criteria includes a criterion that is satisfied when the computer system (e.g., 600) is determined to be within a predefined distance (e.g., 682 and/or 684) (e.g., 1-12 inches) from an external computer system (e.g., 680) (a smart speaker, a television, a display, a smartwatch, a smartphone, a desktop computer, a tablet, and/or a radio), the computer system displays, via the display generation component, a media user interface (e.g., 630) (e.g., the computer system ceases to display the user interface as a part of displaying the media user interface or the computer system continues to display the user interface as part of displaying the media user interface) that includes a first representation (e.g., a graphical representation and/or a textual representation) of a first media item (e.g., 632, 634, 636 and/or 638) from a first media source (e.g., a media library on a computer system, a media library on a server, a respective piece of hardware (e.g., phone, CD, or record) and/or a first media streaming service) and a second representation (e.g., a graphical representation and/or a textual representation) (e.g., the second representation is different and/or distinct from the first representation) of a second media item (e.g., 632, 634, 636 and/or 638) (e.g., the second media item is different and/or distinct from the first media item) (e.g., the second media item and the first media item are the same type of media item (e.g., both the first media item and the second media item are both music media items or video media items) or the second media item and the first media item are different types of media items) from a second media source (e.g., a media library on a computer system, a media library on a server, a respective piece of hardware (e.g., phone, or record) and/or a second media streaming service), wherein the second media source is different from the first media source.

At 804, while displaying the media user interface (e.g., 630), the computer system detects, via the one or more input devices, an input (e.g., 605t) (e.g., a tap input, a long press (e.g., a tap and hold), a swipe input, a voice command, a hand air gesture, and/or a gaze) that corresponds to selection of the first representation (e.g., 632, 634, 636 and/or 638).

At 806, in response to detecting the input that corresponds to selection of the first representation, the computer system transmits instructions to the external computer system that cause the external computer system to initiate playback of the first media item (e.g., 686) (e.g., media item represented by 632, 634, 636, and/or 638) (e.g., as discussed above at FIG. 6U). In some examples, the computer system ceases to display the second representation of the second media item in response to detecting the input. In some examples, the first computer system detects the distance between the first computer system and the external computer system based on a wireless signal strength (e.g., a Bluetooth signal, a Wi-Fi signal, and/or an Ultra-Wideband signal) between the first computer system and the external computer system. In some examples, the computer system displays the first representation of the first media item and the second representation of the second media item in a respective order (e.g., in alphabetical order, in order of when the media item was last played, in an order that corresponds to a rating system, and/or in an order that corresponds to the number of times the respective media item has been played back). In some examples, the computer system ceases to display the media user interface in response to detecting the input. In some examples, the computer system continues to display the first representation of the first media item in response to detecting the input. In some examples, the instructions cause the external computer system to cease playing a respective media item. In some examples, the computer system displays a representation (e.g., a textual representation and/or a graphical representation) of the external computer system prior to or after transmitting the instructions to the external computer system. In some examples, the computer system displays an animation of a representation (e.g., a textual representation and/or a graphical representation) of the external computer system prior to or after transmitting the instructions to the external computer system. In some examples, while displaying the media user interface, detecting, via the one or more input devices, an input (e.g., a tap input, a long press (e.g., a tap and hold), a swipe input, a voice command, a hand air gesture, and/or a gaze) that corresponds to selection of the second representation; and in response to detecting the input that corresponds to selection of the second representation, the computer system transmits instructions to the external computer system that cause the external computer system to initiate playback of the first media item. In some examples, the computer system detects a respective input, determines whether the respective input represents selection of the first representation or the second representation. Transmitting instructions to the external computer system that cause the external computer system to initiate playback of the first media item in response to detecting the input that corresponds to selection of the first representation provides the user with sensory feedback regarding the state of the computer system (e.g., that the computer system has detected the input that corresponds to selection of the first representation), thereby providing improved sensory feedback. Displaying the media user interface automatically when a first set of one or more criteria is satisfied allows the user to control the display of the media user interface without displaying additional controls, thereby providing additional control options without cluttering the user interface. Displaying a media user interface that includes a first representation of a first media item from a first media source and a second representation of a second media item from a second media source provides the user with the ability to simultaneously access media items from a number of different media sources, thereby reducing the number of inputs needed to perform an operation and providing improved visual feedback.

In some examples, the first media source is a first media streaming service (e.g., as discussed above at FIG. 6T) (e.g., an application, media service, website, server, application, and/or entity that delivers media (e.g., video and/or audio) content (e.g., live and/or recorded) (e.g., podcasts, webcasts, movies, television shows, music, and/or music videos) to a consumer's computer system in a compressed and/or non-compressed form over a network). In some examples, the second media source (e.g., is a second media streaming service (e.g., as discussed above at FIG. 6T) (e.g., the first media streaming service is different from the second media streaming service) (e.g., an entity that delivers video and/or audio content (e.g., live and/or recorded) (e.g., podcasts, webcasts, movies, television shows, music, and/or music videos) to a consumer in a compressed and/or non-compressed form over a network)). In some examples, the first media streaming service and the second media streaming service are the same. In some examples, the first media streaming service and the second media streaming service are different. In some examples, the first media streaming service and/or the second media streaming service corresponds to one or more applications that are installed on the first computer system.

In some examples, the first media source is a first type of computer system (e.g., 600 or 680) (e.g., an external smart speaker, memory stored on the smart speaker and/or a removeable storage device that is coupled to the smart speaker) (e.g., an external speaker that has a smart assistant integrated into the speaker and/or an external speaker that is able to process voice commands). In some examples, the second media source is a second type of computer system (e.g., 600 or 680) that is different than the first type of computer system (e.g., as discussed above at FIG. 6T) (e.g., an external smartwatch, memory stored on the smartwatch, and/or a removeable storage device that is coupled to the smartwatch) (e.g., a watch that has a smart assistant integrated into the watch and/or a watch that is able to process voice commands) (e.g., the smartwatch and the computer system correspond to a same user account or different user accounts). In some examples, the first type of device and/or the second type of device is a wearable device. In some examples, the computer system is the first type of computer system and/or the second type of computer system. In some examples, the computer system is not the first type of computer system and/or the second type of computer system. In some examples, the external computer system is the first type of computer system and/or the second type of computer system. In some examples, the external computer system is not the first type of computer system and/or the second type of computer system.

In some examples, displaying the media user interface (e.g., 630) includes displaying a set of recently (e.g., within the last hour, day, week, month, or year) played back media items (e.g., 632, 634, 636 and/or 638) (e.g., recently played back by the computer system, the external computer system and/or a respective external computer system that is linked to a user account that the computer system is linked to) (e.g., recently played via the first media source, the second media source and/or a respective media source) that includes the first media item (e.g., 632, 634, 636 and/or 638) and the second media item (e.g., 632, 634, 636 and/or 638). In some examples, the set of recently played back media items was recently played back by one or more respective computer systems (e.g., 600 and/or 680) of a set of computer systems (e.g., associated with, authorized by, accessed by, logged into, at a location associated with, on a network associated with, and/or used by a user account) that includes the computer system (e.g., 600) and the external computer system (e.g., 680). In some examples, the set of recently played media was recently played back on the computer system and/or an external computer system. In some examples, the set of recently played media items is played back via the first media source and/or the second media source. Displaying representations of media that was recently played back provides the user with visual feedback and quick access to what media items that have been recently played back by a relevant set of computer systems that includes the computer system and the external computer system, thereby providing improved visual feedback and reducing the number of inputs needed to perform an operation.

In some examples, the first set of one or more criteria includes a criterion that is satisfied when a determination is made that the computer system (e.g., 600) is not outputting a respective media item (e.g., 616a and/or 616b) (e.g., 600 at FIGS. 6R, 6S, and/or 6T) (e.g., as described above with respect to method 700) (e.g., the computer system does not output a media item and/or an external computer system that the computer system is configured to control does not output a respective media item) and the external computer system (e.g., 680) is not outputting a respective media item (e.g., 680 at FIGS. 6R, 6S, and/or 6T). Displaying a first representation of a first media item and a second representation of a second media item while the computer system is not outputting a respective item provides a user with visual feedback with respect to the play back status of the computer system and the external computer system, thereby providing improved visual feedback.

In some examples, in accordance with a determination that the first set of one or more criteria is satisfied (e.g., and before displaying the media user interface and/or while displaying the media user interface), the computer system displays, via the display generation component, an animation (e.g., a fading out animation, a fading in animation, and/or a rotation animation) of a representation (e.g., a graphical and/or textual representation) of the external computer system (e.g., 624 at FIG. 6S). In some examples, in accordance with a determination that the first set of one or more criteria is not satisfied, the computer system does not display the animation of the representation of the external computer system. Displaying an animation of a representation of the external computer system when prescribed conditions are met allows the computer system to automatically perform a display operation that indicates to a user the state of the computer system and/or the external computer system, thereby providing additional control options without cluttering the user interface and providing improved visual feedback.

In some examples, displaying the animation of the representation of the external computer system (e.g., 624 at 6S) does not include displaying a representation of a respective media item (e.g., 616a and/or 616b) (e.g., as discussed above at FIG. 6S) (e.g., a media item that was recently output by the computer system and/or the external computer system, a media item that is presently output by the computer system and/or the external computer system, and/or a media item that the computer system and/or the external computer system is configured to output). Displaying the animation of the external computer system without a representation of a respective media item provides a user with visual feedback regarding the state of the external computer system (e.g., the external computer system is presently not playing back a media item), thereby providing improved visual feedback.

In some examples, displaying the media user interface (e.g., 606) includes displaying a navigation user interface object (e.g., 608) (e.g., a back button). In some examples, while displaying the navigation user interface object, the computer system detects a second input (e.g., 605w) (a tap input, a swipe input, and/or a voice command) that corresponds to selection of the navigation user interface object (e.g., 608 at FIG. 6W). In some examples, in response to detecting the second input that corresponds to selection of the navigation user interface object, the computer system displays, via the display generation component, a first representation of a second external computer system (e.g., 654, 656, and/or 658) (e.g., a smartphone, a smart watch, one or more speakers, a desktop computer and/or a tablet) (e.g., the second external computer system and the computer system are wirelessly connected (e.g., Bluetooth, Wi-Fi, and/or Ultra-Wideband) and/or connected via a wire) and a second representation of a third external computer system (e.g., 654, 656, and/or 658) (e.g., a smartphone, a smart watch, one or more speakers, a desktop computer and/or a tablet) (e.g., the third external computer system and the computer system are wirelessly connected (e.g., Bluetooth, Wi-Fi, and/or Ultra-Wideband) and/or connected via a wire). In some examples, while displaying the first representation of the second external computer system (e.g., 654, 656, and/or 658) and the second representation of the third external computer system (e.g., 654, 656, and/or 658), the computer system detects a third input (e.g., 6051, 605o, 605q, 605t, 605u, 605v, and/or 605w) (e.g., as discussed above at FIG. 6X) (a tap input, a swipe input, and/or a voice command) that corresponds to selection of the first representation of the second external computer system (e.g., location of 654, 656, and/or 658 at FIG. 6X). In some examples, in response to detecting the third input that corresponds to selection of the first representation of the second external computer system, the computer system displays, via the display generation component, a first now playing user interface (e.g., 606) that corresponds to (e.g., controls playback of, displays information regarding media playing back on, and/or includes one or more playback control user interface objects for changing playback and/or causing playback events (e.g., play, pause, next, and/or back) of) the second external computer system (e.g., computer system represented by 654, 656, and/or 658). In some examples, in response to detecting the third input, the computer system configures itself to change a playback status of the second external computer system (e.g., modify the volume, pause playback, and/or initiate playback of different media) (e.g., and not causing a playback status of the third external computer system to change). In some examples, the computer system ceases to display the media user interface in response to detecting an input that corresponds to selection of the back user interface object. In some examples, the computer system maintains the display of the media user interface in response to detecting an input that corresponds to selection of the back user interface object. Displaying a first representation of the second external computer system and a second representation of a third external computer system provides the user with feedback regarding the state of the computer system (e.g., the computer system has detected the second input), thereby providing improved visual feedback.

In some examples, in response to detecting the input (e.g., 605t) that corresponds to selection of the first representation of the first media item (e.g., 632, 634, 636 and/or 638), the computer system displays (e.g., before, during and/or after transmitting instructions to the external computer that cause the external computer system to initiate playback of the first media item) a second now playing user interface (e.g., 606 at FIG. 6U), wherein displaying the second now playing user interface (e.g., 606) includes displaying a third representation (e.g., textual representation and/or a graphical representation) (e.g., the third representation of the first media item and the first representation of the first media item are the same or are different (e.g., different size, different shape, and/or different color)) of the first media item (e.g., 616 at FIG. 6U). In some examples, the computer system ceases to display the media user interface as a part of displaying the second now playing user interface. Displaying a now playing user interface in response to detecting an input that corresponds to selection of the first representation of the first media item provides a user with visual feedback regarding the state of the computer system (e.g., the computer system detects the input that corresponds to selection of the first representation of the first media item), thereby providing improved visual feedback.

In some examples, displaying the media user interface (e.g., 630) includes displaying a first representation (e.g., a textual representation and/or a graphical representation) of the external computer system at a first size (e.g., 614 at FIG. 6T) (e.g., 0.1-1 inch in width) without displaying a playback control user interface object (e.g. 618a, 618b, 618c, and/or 618d) (e.g., corresponding to a respective external computer, wherein the computer system adjusts (e.g., initiates the output, pauses the output, increases a volume level, and/or decreases a volume level) an output operation of the respective external computer system in response to detecting an input that corresponds to selection of the playback control user interface object) (e.g., for changing playback and/or causing playback events (e.g., play, pause, next, and/or back) the external computer system). In some examples, displaying the second now playing user interface (e.g., 606) includes displaying a second representation of the external computer system (e.g., same as or different from the first representation of the external computer system) at a second size (e.g., 614 at FIG. 6U) that is different (e.g., larger, smaller, 1.5×, 2×, 3×, 4×, or 10× larger than) from the first size while displaying the playback control user interface object (e.g., as discussed above at FIG. 6U). In some examples, the computer system displays the representation of a respective computer system corresponding to a representation of a respective media item (e.g., the computer system displays the representation of the respective computer system at one or more locations that correspond to the representation of a respective media item if the media item was recently output by the respective external computer system). Displaying a representation of the computer system at a respective size based on whether the computer system displays the media user interface or whether the computer system displays the now playing user interface provides a user with visual feedback regarding whether the computer system is displaying the now playing user interface or the media user interface, thereby providing improved visual feedback.

In some examples, the input corresponds to a tap input (e.g., 6051, 605o, 605q, 605t, 605u, 605v, and/or 605w). In some examples, the input corresponds to a swipe input, a long press (e.g., a tap and hold), a rotation of a rotatable crown, a depression of a rotatable crown, a voice command, and/or an air hand gesture.

Note that details of the processes described above with respect to method 800 (e.g., FIG. 8) are also applicable in an analogous manner to the methods described herein. For example, method 700 optionally includes one or more of the characteristics of the various methods described above with reference to method 800. For example, the computer system at method 700 can be configured to control the playback of an external computer system in response to the computer system detecting an input that corresponds to a representation of the external computer system. For brevity, these details are not repeated below.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

As described above, one aspect of the present technology is the gathering and use of data available from various sources to improve a media playback experience for users. The present disclosure contemplates that in some instances, this gathered data may include personal information data that uniquely identifies or can be used to contact or locate a specific person. Such personal information data can include demographic data, location-based data, telephone numbers, email addresses, twitter IDs, home addresses, data, or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to deliver a user-specific media playlist to users. Accordingly, use of such personal information data enables users to have access to personalized playlists. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of media streaming services, the present technology can be configured to allow users to select to “opt in” or “opt out” of participation in the collection of personal information data during registration for services or anytime thereafter. In another example, users can select not to provide media data for the creation of personalized playlists. In yet another example, users can select to limit the length of time media data is maintained or entirely prohibit the development of a baseline media profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, media playlists selected and delivered to users by inferring preferences based on non-personal information data or a bare minimum amount of personal information, such as the content being requested by the device associated with a user, other non-personal information available to the media streaming services, or publicly available information.

What is claimed is:

1. A method, comprising:
at a first computer system that is in communication with a display generation component:
in accordance with a determination that a first set of one or more criteria is satisfied while a second computer system is outputting media, wherein the first set of one or more criteria includes a criterion that is satisfied when the first computer system is determined to be within a predefined distance from a third computer system while the second computer system is outputting media:
causing, the third computer system, to output the media; and
changing, via the display generation component, a display location of a first representation of the media from a first location to a second location, wherein the second location corresponds to a display location of a representation of the third computer system and the first location does not correspond to a location of the display location of the first representation of the third computer system; and
in accordance with a determination that a second set of one or more criteria is satisfied, wherein the second set of one or more criteria includes a criterion that is satisfied when the first computer system is determined to be within the predefined distance from the third computer system while the second computer system is outputting media:
forgoing causing the third computer system to output respective media; and
forgoing changing the display location of the first representation of the media from the first location to the second location.

2. The method of claim 1, wherein the first set of one or more criteria includes a criterion that is satisfied when the third computer system is determined to be not outputting media.

3. The method of claim 1, wherein the second set of one or more criteria includes a criterion that is satisfied when the third computer system is determined to be outputting media.

4. The method of claim 1, further comprising:
in accordance with a determination that the first set of one or more criteria is satisfied while the second computer system is outputting media, causing the second computer system to cease the output of the media.

5. The method of claim 1, further comprising:
in accordance with a determination that a third set of one or more criteria is satisfied, wherein the third set of one or more criteria includes a criterion that is satisfied when the first computer system is determined to be within a second predefined distance from the third computer system but not within the predefined distance from the third computer system, displaying, via the display generation component, a user interface indicating that the first computer system is not within the predefined distance from the third computer system.

6. The method of claim 1, wherein the first computer system is in communication with a fourth computer system different from the first computer system, the method further comprising:
in accordance with a determination that a fourth set of one or more criteria is satisfied while the fourth computer system outputs a second media item, wherein the fourth set of one or more criteria includes a criterion that is satisfied when the first computer system is determined to be within the predefined distance from the third computer system:
causing the third computer system to initiate output of the second media item.

7. The method of claim 1, wherein changing the display location of the first representation of the media from the first location to the second location includes displaying the first representation of the media as overlaid on the first representation of the third computer system.

8. The method of claim 1, further comprising:
in accordance with a determination that the second set of one or more criteria is satisfied, displaying a second representation of the respective media as overlaid on a second representation of the third computer system.

9. The method of claim 1, further comprising:
in accordance with a determination that the first set of one or more criteria is satisfied, after causing the third computer system to output the media, displaying, via the display generation component, a first now playing user interface that includes a third representation of the media; and
in accordance with a determination that the second set of one or more criteria is satisfied, while the second computer system is outputting the media, displaying, via the display generation component, the first now playing user interface that includes the third representation of the media.

10. The method of claim 9, wherein:
after changing the display location of the first representation of the media from the first location to the second location and in accordance with a determination that the first set of one or more criteria is satisfied, the third representation of the media is displayed at a first position of the first now playing user interface; and
in accordance with a determination that the second set of one or more criteria is satisfied, the third representation the media is displayed at a second position of the first now playing user interface.

11. The method of claim 9, wherein, in accordance with a determination that the second set of one or more criteria is satisfied and after forgoing changing the display location of the first representation of the media from the first location to the second location, displaying the first now playing user interface includes displaying a first transfer user interface object, that, when selected, causes the first computer system to transmit instructions to the third computer system that causes the transfer of the playback of the respective media.

12. The method of claim 11, wherein, in accordance with a determination that the first set of one or more criteria is satisfied, the first now playing user interface does not include the first transfer user interface object.

13. The method of claim 11, wherein the first now playing user interface continues to be displayed without respect to a distance between the first computer system and the third computer system.

14. The method of claim 1, further comprising:
in accordance with a determination that a third set of one or more criteria is satisfied, wherein the third set of one or more criteria includes a criterion that is satisfied when the first computer system is determined to be within the predefined distance from the third computer system while the third computer system is outputting media, displaying, via the display generation component, a second transfer user interface object.

15. The method of claim 14, further comprising:
in accordance with a determination that a third set of one or more criteria is satisfied, displaying a third representation of the third computer system concurrently with the second transfer user interface object.

16. A non-transitory computer-readable storage medium storing one or more programs configured to be executed by one or more processors of a first computer system that is in communication with a display generation component, the one or more programs including instructions for:
in accordance with a determination that a first set of one or more criteria is satisfied while a second computer system is outputting media, wherein the first set of one or more criteria includes a criterion that is satisfied when the first computer system is determined to be within a predefined distance from a third computer system while the second computer system is outputting media:
causing, the third computer system, to output the media; and
changing, via the display generation component, a display location of a first representation of the media from a first location to a second location, wherein the second location corresponds to a display location of a representation of the third computer system and the first location does not correspond to a location of the display location of the first representation of the third computer system; and
in accordance with a determination that a second set of one or more criteria is satisfied, wherein the second set of one or more criteria includes a criterion that is satisfied when the first computer system is determined to be within the predefined distance from the third computer system while the second computer system is outputting media:
forgoing causing the third computer system to output respective media; and
forgoing changing the display location of the first representation of the media from the first location to the second location.

17. A first computer system that is in communication with a display generation component, comprising:
one or more processors; and
memory storing one or more programs configured to be executed by the one or more processors, the one or more programs including instructions for:
in accordance with a determination that a first set of one or more criteria is satisfied while a second computer system is outputting media, wherein the first set of one or more criteria includes a criterion that is satisfied when the first computer system is determined to be within a predefined distance from a third computer system while the second computer system is outputting media:
causing, the third computer system, to output the media; and
changing, via the display generation component, a display location of a first representation of the media from a first location to a second location, wherein the second location corresponds to a display location of a representation of the third computer system and the first location does not correspond to a location of the display location of the first representation of the third computer system; and
in accordance with a determination that a second set of one or more criteria is satisfied, wherein the second set of one or more criteria includes a criterion that is satisfied when the first computer system is determined to be within the predefined distance from the third computer system while the second computer system is outputting media:
forgoing causing the third computer system to output respective media; and
forgoing changing the display location of the first representation of the media from the first location to the second location.
